(19) United States
(12) Patent Application Publication
(10) Pub. No.: US 2015/0289524 A1
(43) Pub. Date: Oct. 15, 2015

(54) METHOD FOR THE CONTINUOUS PRODUCTION OF ROLL WAFERS HAVING A SHORT TEXTURE

(71) Applicant: HAAS FOOD EQUIPMENT GMBH, WIEN (AT)

(72) Inventors: Johannes Haas, Wien (AT); Josef Haas, Leobendorf (AT); Stefan Jiraschek, Koenigsbrunn (AT); Karl Tiefenbacher, Wien (AT)

(21) Appl. No.: 14/389,423

(22) PCT Filed: Mar. 12, 2013
(86) PCT No.: PCT/EP2013/054988

§ 371 Date: Sep. 30, 2014

(30) Foreign Application Priority Data
Mar. 30, 2012 (AT) A 393/2012

(51) Int. Cl. A21D 13/00; A21D 8/06

(52) U.S. Cl. CPC A21D 13/0035; A21D 8/06

(57) ABSTRACT

A method for the continuous production of roll wafers having a short texture, includes applying a shortenable baking mass to a moving heated baking surface to form an endless baked strip, baking the baked strip substantially dry during the movement, then at least partially removing the baked strip in a hot plastic state from the baking surface and feeding the baked strip to a rolling apparatus, winding the baked strip around a rolling mandrel in the rolling apparatus and forming the baked strip into an endless hollow tube, and filling, coating, spray-coating and/or bringing the baked strip and/or the hollow tube into contact at the same time, before or afterwards with a shortening agent for shortening.

The invention relates to a method for the continuous production of roll wafers having a short texture and the use of an annular baking machine for the continuous production of roll wafers having a short texture.

Apparatus for the continuous production of roll wafers having a crispy brittle texture are published, for example, in the following documents:

AT 314 960 B; filed on 14 Jun. 1971 and published on 10 May 1974

AT 375 005 B; filed on 7 Sep. 1981 and published on 25 Jun. 1984

AT 386 981 A; filed on 7 Sep. 1981 and published on 15 November 1983

AT 380 151 B; filed on 16 Sep. 1982 and published on 25 Apr. 1986

AT 409 703 B; filed on 13 Dec. 1996 and published on 25 October 2002

Reference is made to the content of these documents and the content of the documents is included in the present application.

In such baking machines, which are also known as annular baking machines or drum baking machines, a heated baking ring is rotated continuously about its central axis. In this case, the baking mass is applied to at least one side of the baking ring and baked on the surface of the baking ring. The endless baked strip thereby formed is removed in an area remote from the dough application and wound continuously around a rolling mandrel in a rolling apparatus. Here endless roll-shaped bodies are formed in which the wafer strip is deformed in a spirally overlapping manner in the still-hot state and solidified subsequently with the cooling. These endless roll-shaped bodies are filled subsequently, for example, by injection of a mass or coated internally and cut into pieces of desired length.

According to the prior art, the industrial production of continuously baked roll wafers such as wafer rolls or hollow wafer sticks starts from sugar-rich wafer baking masses which are exclusively suitable for the production of crispy-brittle roll wafers. The starting material for the production of these roll wafers or wafer rolls is a baking mass having a sugar fraction of about 70 parts of sugar to 100 parts of flour such as is described, for example, in EP 1437045 A1 and WO 2000005966. The baking mass is applied as an endless strip to a rotating baking drum or to a baking ring and baked. This high sugar content is necessary to give the ready-baked hot wafer strip the necessary flexibility for rolling, but at the same time results in a brittle glassy texture after solidification of the high sugar fraction.

AT 380151 also describes the technique of endless baking of flowable baking masses and the various possibilities for subsequently shaping the baked wafer strip. Optionally the inner side is coated with chocolate or sugar fat creams during the rolling process or the wafer tube is completely filled.

The industrial production of roll wafers is limited to sugar-rich, low-fat baking masses. The high sugar content is required since the molten sugar serves as a plasticizing means which allows the still-hot sugar wafer strip to be rolled, embossed, pressed etc. directly after baking. With the cooling the structure of the wafer goods thus obtained then solidifies due to the glassy solidification of the sugar to give a crispy-brittle texture.

Superior-tasting products having a short texture such as Japanese butter rolled biscuits of the type “Fugetsudo Papillotes” or “Yokumoku Cigars” cannot be produced with the continuous method for producing roll wafers corresponding to the prior art. Rather, flat round cakes are baked in an expensive process, lifted from the baking mould and rolled individually.

The high sugar fraction in the composition of the baking mass for continuously produced roll wafers such as wafer rolls or hollow wafer tubes made of sugar-rich wafer baking masses substantially determines, together with the flour which forms the second main component, the texture of the end product. In this context, the overall impression of the consistency of the finished product comprising parameters or sensory impressions such as brittleness, toughness, softness, friability, hardness etc. is designated as texture. Since the sugar solidifies in a glassy manner during cooling, the thin layers of the finished roll wafers also have a very crunchy, splintery crisp-brittle texture which ranks essentially among the quality features of known baked goods.

The taste of these wafer-tube baked goods is also substantially determined by the sugar fraction and the flavorings which are produced by Maillard reactions between sugar substances and proteins. Proteins originate predominantly from the flour fraction and from small fractions of egg powder and/or milk powder which are also used if necessary.

According to a prejudice of the professional circles, it is not possible to produce roll wafers having a short texture on the existing machines for producing roll wafers such as hollow wafer tubes since all the components of the baking mass which cause a short texture result in a significant reduction in the strength of the wafer strip after baking. This has the result that the baked strip tears when released from the baking drum and therefore can no longer be rolled continuously in the rolling apparatus. The fat content of hollow wafer tubes corresponding to the prior art lies in the range of about 3% to about 14%. Higher fat fractions to achieve a short texture cannot be used according to known methods and apparatus since the back-greasing of the baking wafer strip onto the baking drum leads to a fat enrichment on the surface and makes reliable permanent operation impossible. This results in a slipping of the wafer strip to be baked from the baking drum or to ignition of the excess fat. Furthermore, higher fat fractions in the baking mass recipe also result in a tearing of the baked rolled wafer strip, which can be attributed to the shortening or softening effect of higher fat fractions. The shortening effect of higher fat fractions as is known from short crust pastry baked goods, therefore cannot be used in the industrial continuous manufacture of roll wafers corresponding to the prior art for an improvement in texture and taste of roll wafers.

Other components for producing desired higher-quality short and tasty roll wafers are the provision of higher fractions of egg which, for example, is used as pasteurized whole egg, frozen egg or egg powder, higher fractions of milk-based components or other flavoring components.

A higher egg fraction alone, possibly adding higher milk fractions and nut components, however is not sufficient to achieve a significant improvement in the quality in texture and taste. This is also reflected in the fact that in usual wafer tube products on the market, either no egg or milk powder or only small fractions up to a maximum of 3% egg powder and/or milk powder relative to the quantity of the other powdery main components flour and sugar, are used. The addition of these relatively costly ingredients without a qualitative improvement in the product would be an inefficient process.

Another possibility for improving the quality of the roll wafers is filling the roll wafer body by infusion with sugar-fat masses such as chocolate or cream fillings in various flavors. An additional flavoring, also with thermally sensitive and water-vapor-volatile flavors can also be achieved via these filling masses. The essential quality features of these products are the combination of the crunchy-crisp texture of the roll wafers with a soft, aromatic filling, where the outer side is not tainted with fat and flavors.

It is now the object of the invention to provide an efficient method for producing roll wafers which additionally have a short texture and impart a high-quality taste-intensive impression and taste themselves without additional filling. This object comprises being able to produce the roll wafers having a short texture continuously and/or as an endless product and thereby achieving the positive properties of the individually rolled butter rolled biscuits described above, i.e. short texture and taste.

The object according to the invention is solved by a method which comprises the following steps:
a. a shortenable baking mass is applied to a moving heated baking surface to form an endless baked strip,
b. the baked strip is baked substantially dry during the movement
c. the baked strip in a hot plastic state is then removed at least partially from the baking surface and fed to a rolling apparatus
d. wherein the baked strip is wound around a rolling mandrel in the rolling apparatus and formed into an endless hollow tube
e. and wherein the baked strip and/or the hollow tube is filled, coated, spray-coated and/or brought in contact at the same time, before or afterwards with a shortening agent for shortening.

Further process steps according to the invention are that the hollow tube is reshaped, in particular pressed, stamped, cut, divided into pieces, embossed and/or sealed by compressing the lateral cut ends and/or that after application of the shortening agent, the hollow tube or the baked strip is moved along its principal direction of extension and/or horizontally and preferably rotated at the same time until the shortening agent is incorporated.

Furthermore, the method is characterized in that relative to 100 parts of flour and/or high-starch flours the baking mass comprises the following ingredients:
f. sugar: 65 to 105, preferably 75 to 100
g. fat: less than 14, preferably less than 8, particularly preferably less than 6.5
h. whole egg: 18 to 112, preferably 38 to 112 or equivalent quantities of animal or vegetable proteins serving as replacement for the egg protein.

Further process features are that the baking mass comprises ingredients which lie in the range of the ingredients of baking masses A, baking masses B, baking masses C, baking masses D, baking masses E1, baking masses E2, baking masses F, baking masses G and/or baking masses H and/or that the baking mass substantially corresponds to one of baking masses A, baking masses B, baking masses C, baking masses D, baking masses E1, baking masses E2, baking masses F, baking masses G and/or one of baking masses H. In is noted that the said baking masses are exemplary baking masses. Modifications or mixtures of these baking masses which are shortenable by the method according to the invention are covered by the designation “shortenable baking mass” according to the invention. Thus, it is consistent with the inventive idea that the baking mass has ingredients which lie within the range of the ingredients of one or more of all of the shortenable baking masses A, baking masses B, baking masses C, baking masses D, baking masses E1, baking masses E2, baking masses F, baking masses G or baking masses H.

According to the invention, it is preferably provided that the shortening agent is or comprises melted butter fat, butter oil, melted butter, melted margarine, lard, coconut oil, hardened coconut oil, palm olein and/or other vegetable oils or melted fats, optionally with added flavoring, that the roll wafers produced, or comprises the fact that the roll wafers produced by reshaping are packaged directly afterwards to protect against moisture ingress, air oxygen and for hygiene reasons, that the baking mass is flowable, that the baking surface corresponds to an outer surface or an inner surface of a baking ring which is rotated about its axis of rotation, that the endless baked strip is released by a scraper knife and/or that the shortening agent is added during the rolling process via a central bore in the rolling mandrel.

The invention also relates to the use of an annular baking machine for the continuous production of roll wafers having a short texture. To this end it is preferably provided that the roll wafers having a shortenable texture comprise a shortenable baked baking mass and a shortening agent, that the shortening agent is applied or can be applied to the shortenable baked baking mass and/or that the baking mass relative to 100 parts of flour and/or high-starch flour comprises the following ingredients:
i. sugar: 65 to 105, preferably 75 to 100
j. fat: less than 14, preferably less than 8, particularly preferably less than 6.5
k. whole egg: 18 to 112, preferably 38 to 112 or equivalent quantities of animal or vegetable proteins serving as replacement for the egg protein.

Furthermore, the use of an annular baking machine according to the invention is characterized in that the baking mass comprises ingredients which lie in the range of the ingredients of baking masses A, baking masses B, baking masses C, baking masses D, baking masses E1, baking masses E2, baking masses F, baking masses G or baking masses H and/or that the baking mass substantially corresponds to one of baking masses A, baking masses B, baking masses C, baking masses D, baking masses E1, baking masses E2, baking masses F, baking masses G or one of baking masses H.

Roll wafers are produced by the method according to the invention which are superior in quality to conventional continuously produced roll wafers both in terms of taste and with regard to their texture. Thus, products having a short texture similar to the Japanese butter rolled biscuits of the “Fugetsudo Papillotes” type or Yokumoku Cigars” can be produced in a continuous method without expensive batch production. This is achieved by a combination of modified recipe, i.e. modified composition of the baking mass and the use of shortening fats or shortening agents and by the method of manufacture according to the invention. The desired positive properties of short texture and high-quality taste are achieved according to the invention by the combined use of flavoring, preferably non-high-starch raw materials in the baking mass and the infusion or the application of preferably liquid or thermally liquefied shortening agents from the group of oils, fats or high-fat emulsions, in particular vegetable oils, margarines and animal fats such as butter, butter olein, clarified butter, lard or other fats in liquid form and the flavored oils, fats or high-fat emulsions, in particular flavored vegetable oils, margarines and animal fats such as flavored butter, butter olein, clarified butter, lard or other flavored fats in liquid form during the rolling process or after the rolling process. Flavoring non-high-starch raw materials in the baking mass are, for example, higher fractions of egg, egg powder or liquid egg, whey protein, milk-based raw materials, nut flours, nut pastes, cocoa, chocolate, coffee, tea or tea-based extracts, soya flour, lupin flour, coconut-based raw materials, spices and other seasonings etc.

Optionally, the roll wafers can be filled or coated with additional filling masses or chocolate.

The shortening effect of fats which has a positive influence on the taste is achieved by introducing flowable pasty or liquid fats or high-fat mixtures of fats with flavoring or coloring substances via the filling device into the interior of the hollow tube of the roll wafer directly after rolling in order to obtain a product which hitherto could not be produced on continuously operating roll wafer machines. Consequently, contrary to a prejudice of the professional circles, a method is provided in which higher-fat roll wafer products can be produced by means of the industrial hollow wafer tube technique which have a fat content of 14 to 42%, preferably 22 to 40%, particularly preferably 29 to 38%. Due to the higher fat fraction and the increased fraction of non-high-starch flavoring raw materials amenable to shortening by fats, the texture of these roll wafers is changed to a short, delicate texture.

The introduction of fats which in combination with an increased fraction of non-starch components in the baking mass recipe lead to the desired short texture is preferably accomplished by liquid infusion during rolling the wafer strip. As a result, the outer side of the finished product contains less fat or becomes less fatty which has advantages in handling, particular for gripping. However, other known methods of fat application after rolling such as spraying, passing an impregnating curtain etc. can be used to introduce the shortening fat fractions. The preferred method of liquid infusion advantageously allows a precise control of the quantity of fat introduced.

Exemplary embodiments of baking masses and infusion masses or shortening agents for use in the method according to the invention are subsequently defined in more detail:

Baking masses A - shorter texture/better flavour - egg powder

| | 50% egg | | 45% egg | | 40% egg | |
|---|---|---|---|---|---|---|
| | fraction | | fraction | | fraction | |
| Raw materials | kg | % | kg | % | kg | % |
| Water | 15.4 | 39.47 | 15.1 | 39.61 | 14.75 | 39.61 |
| Sugar | 10 | 25.63 | 9.7 | 25.45 | 9.375 | 25.18 |
| Butter-vanilla | 0.1 | 0.26 | 0.1 | 0.26 | 0.1 | 0.27 |
| flavoring | | | | | | |
| Whole egg powder | 3.095 | 7.93 | 2.71 | 7.11 | 2.35 | 6.31 |
| Whole egg, | 0 | 0.00 | 0 | 0.00 | 0 | 0.00 |
| pasteurised | | | | | | |
| Salt | 0.22 | 0.56 | 0.21 | 0.55 | 0.21 | 0.56 |
| Wheat flour | 10 | 25.63 | 10 | 26.23 | 10 | 26.86 |
| Butter fat | 0.2 | 0.51 | 0.3 | 0.79 | 0.45 | 1.21 |
| Total | 39.015 | 100 | 38.12 | 100 | 37.235 | 100 |

| | 35% egg | | 30% egg | | 25% egg | |
|---|---|---|---|---|---|---|
| | fraction | | fraction | | fraction | |
| Raw materials | kg | % | kg | % | kg | % |
| Water | 14.45 | 39.69 | 14.1 | 39.70 | 14.5 | 40.97 |
| Sugar | 9.06 | 24.88 | 8.7 | 24.50 | 8.45 | 23.87 |
| Butter-vanilla | 0.1 | 0.27 | 0.1 | 0.28 | 0.1 | 0.28 |
| flavoring | | | | | | |
| Whole egg powder | 2 | 5.49 | 1.67 | 4.70 | 1.356 | 3.83 |
| Whole egg, | 0 | 0.00 | 0 | 0.00 | 0 | 0.00 |
| pasteurised | | | | | | |
| Salt | 0.2 | 0.55 | 0.195 | 0.55 | 0.19 | 0.54 |
| Wheat flour | 10 | 27.46 | 10 | 28.16 | 10 | 28.25 |
| Butter fat | 0.6 | 1.65 | 0.75 | 2.11 | 0.8 | 2.26 |
| Total | 36.41 | 100 | 35.515 | 100 | 35.396 | 100 |
| | 20% egg | | 15% egg | | 10% egg | |
| | fraction | | fraction | | fraction | |
| Raw materials | kg | % | kg | % | kg | % |
| Water | 13.55 | 39.87 | 13.1 | 40.01 | 13 | 40.03 |
| Sugar | 8.1 | 23.83 | 7.8 | 23.82 | 7.5 | 23.09 |
| Butter-vanilla | 0.1 | 0.29 | 0.1 | 0.31 | 0.1 | 0.31 |
| flavoring | | | | | | |
| Whole egg powder | 1.055 | 3.10 | 0.76 | 2.32 | 0.5 | 1.54 |
| Whole egg, | 0 | 0.00 | 0 | 0.00 | 0 | 0.00 |
| pasteurised | | | | | | |
| Salt | 0.18 | 0.53 | 0.18 | 0.55 | 0.175 | 0.54 |
| Wheat flour | 10 | 29.42 | 10 | 30.54 | 10 | 30.79 |
| Butter fat | 1 | 2.94 | 0.8 | 2.44 | 1.2 | 3.70 |
| Total | 33.985 | 100 | 32.74 | 100 | 32.475 | 100 |

Baking masses B: shorter texture/better flavor - whole egg

| | 50% egg | | 45% egg | | 40% egg | |
|---|---|---|---|---|---|---|
| | fraction | | fraction | | fraction | |
| Raw materials | kg | % | kg | % | kg | % |
| Water | 7.3 | 18.74 | 8 | 21.01 | 8.6 | 23.13 |
| Sugar | 10 | 25.67 | 9.7 | 25.48 | 9.375 | 25.21 |
| Butter-vanilla | 0.1 | 0.26 | 0.1 | 0.26 | 0.1 | 0.27 |
| flavoring | | | | | | |
| Whole egg powder | 0 | 0.00 | 0 | 0.00 | 0 | 0.00 |
| Whole egg, | 11.14 | 28.59 | 9.76 | 25.64 | 8.45 | 22.72 |
| pasteurised | | | | | | |
| Salt | 0.22 | 0.56 | 0.21 | 0.55 | 0.21 | 0.56 |
| Wheat flour | 10 | 25.67 | 10 | 26.27 | 10 | 26.89 |
| Butter fat | 0.2 | 0.51 | 0.3 | 0.79 | 0.45 | 1.21 |
| Total | 38.96 | 100 | 38.07 | 100 | 37.185 | 100 |
| | 35% egg | | 30% egg | | 25% egg | |
| | fraction | | fraction | | fraction | |
| Raw materials | kg | % | kg | % | kg | % |
| Water | 9.2 | 25.20 | 9.75 | 27.47 | 10.95 | 30.96 |
| Sugar | 9.06 | 24.92 | 8.7 | 24.51 | 8.45 | 23.89 |
| Butter-vanilla | 0.1 | 0.28 | 0.1 | 0.28 | 0.1 | 0.28 |
| flavoring | | | | | | |
| Whole egg powder | 0 | 0.00 | 0 | 0.00 | 0 | 0.00 |
| Whole egg, | 7.2 | 19.80 | 6 | 16.90 | 4.88 | 13.80 |
| pasteurised | | | | | | |
| Salt | 0.2 | 0.55 | 0.195 | 0.55 | 0.19 | 0.54 |
| Wheat flour | 10 | 27.50 | 10 | 28.17 | 10 | 28.27 |
| Butter fat | 0.6 | 1.65 | 0.75 | 2.11 | 0.8 | 2.26 |
| Total | 36.36 | 100 | 35.495 | 100 | 35.37 | 100 |
| | 20% egg | | 15% egg | | 10% egg | |
| | fraction | | fraction | | fraction | |
| Raw materials | kg | % | kg | % | kg | % |
| Water | 11 | 32.18 | 11.1 | 33.92 | 11.7 | 36.03 |
| Sugar | 8.1 | 23.70 | 7.8 | 23.84 | 7.5 | 23.09 |
| Butter-vanilla | 0.1 | 0.29 | 0.1 | 0.31 | 0.1 | 0.31 |
| flavoring | | | | | | |
| Whole egg powder | 0 | 0.00 | 0 | 0.00 | 0 | 0.00 |
| Whole egg, | 3.8 | 11.12 | 2.74 | 8.37 | 1.8 | 5.54 |
| pasteurised | | | | | | |
| Salt | 0.18 | 0.53 | 0.18 | 0.55 | 0.175 | 0.54 |
| Wheat flour | 10 | 29.26 | 10 | 30.56 | 10 | 30.79 |
| Butter fat | 1 | 2.93 | 0.8 | 2.44 | 1.2 | 3.70 |
| Total | 34.18 | 100 | 32.72 | 100 | 32.475 | 100 |

Baking masses C: shorter texture/better flavor - variants 1

| | Cocoa A | | Coconut A | | Coffee A | |
|---|---|---|---|---|---|---|
| Raw materials | kg | % | kg | % | kg | % |
| Water | 15.1 | 40.46 | 14.1 | 37.54 | 15 | 39.16 |
| Sugar colour | 0.1 | 0.27 | 0 | 0.00 | 0 | 0.00 |
| Sugar | 9.3 | 24.92 | 9.55 | 25.43 | 9.75 | 25.46 |
| Coffee, roasted | 0 | 0.00 | 0 | 0.00 | 0.4 | 1.04 |
| ground | | | | | | |
| Coconut cream | 0 | 0.00 | 1.2 | 3.20 | 0 | 0.00 |
| Cocoa powder | 0.4 | 1.07 | 0 | 0.00 | 0 | 0.00 |
| Flavoring | 0.1 | 0.27 | 0.1 | 0.27 | 0.1 | 0.26 |
| Whole | 2.325 | 6.23 | 2.395 | 6.38 | 2.44 | 6.37 |
| egg powder | | | | | | |
| Salt | 0.2 | 0.54 | 0.21 | 0.56 | 0.21 | 0.55 |
| Wheat flour | 9.6 | 25.72 | 10 | 26.63 | 10 | 26.11 |
| Butter | 0.2 | 0.54 | 0 | 0.00 | 0.4 | 1.04 |
| Total | 37.325 | 100 | 37.555 | 100 | 38.3 | 100 |

Baking masses D: shorter texture/better flavor - variants 2

| | Cocoa B | | Coconut B | | Coffee B | |
|---|---|---|---|---|---|---|
| Raw materials | kg | % | kg | % | kg | % |
| Water | 9 | 24.1 | 7.9 | 21.03 | 8.6 | 22.45 |
| Sugar colour | 0.1 | 0.27 | 0 | 0.00 | 0 | 0.00 |
| Sugar | 9.3 | 24.95 | 9.55 | 25.43 | 9.75 | 25.45 |
| Coffee, roasted | 0 | 0.00 | 0 | 0.00 | 0.4 | 1.04 |
| ground | | | | | | |
| Coconut cream | 0 | 0.00 | 1.2 | 3.19 | 0 | 0.00 |
| Cocoa powder | 0.4 | 1.07 | 0 | 0.00 | 0 | 0.00 |
| Whole egg, | 8.37 | 22.46 | 8.6 | 22.90 | 8.8 | 22.97 |
| pasteurised | | | | | | |
| Flavoring | 0.1 | 0.27 | 0.1 | 0.27 | 0.1 | 0.26 |
| Salt | 0.2 | 0.54 | 0.21 | 0.56 | 0.21 | 0.55 |
| Wheat flour | 9.6 | 25.76 | 10 | 26.62 | 10 | 26.10 |
| Butter | 0.2 | 0.54 | 0 | 0.00 | 0.45 | 1.17 |
| Total | 37.27 | 100 | 37.56 | 100 | 38.31 | 100 |

Baking masses E1: shorter texture/better flavor - variants 3

| | Almond A | | Peanut A | | Gingerbread A | |
|---|---|---|---|---|---|---|
| Raw materials | kg | % | kg | % | kg | % |
| Water | 15.5 | 39.09 | 15.5 | 39.09 | 14.7 | 39.68 |
| Sugar | 10.1 | 25.47 | 10.1 | 25.47 | 9.3 | 25.10 |
| Gingerbread spices, | 0 | 0.00 | 0 | 0.00 | 0.4 | 1.08 |
| ground | | | | | | |
| Flavoring | 0.1 | 0.25 | 0.1 | 0.25 | 0.1 | 0.27 |
| Whole egg powder | 2.54 | 6.41 | 2.54 | 6.41 | 2.34 | 6.32 |
| Salt | 0.21 | 0.53 | 0.21 | 0.53 | 0.21 | 0.57 |
| Peanut butter | 0 | 0.00 | 1.2 | 3.03 | 0 | 0.00 |
| Almond flour | 1.2 | 3.03 | 0 | 0.00 | 0 | 0.00 |
| Wheat flour | 10 | 25.22 | 10 | 25.22 | 10 | 26.99 |
| Butter | 0 | 0.00 | 0 | 0.00 | 0 | 0.00 |
| Total | 39.65 | 100 | 39.65 | 100 | 37.05 | 100 |

Baking masses E2: shorter texture/better flavor - variants 4

| | Almond B | | Peanut B | | Gingerbread B | |
|---|---|---|---|---|---|---|
| Raw materials | kg | % | kg | % | kg | % |
| Water | 8.9 | 22.45 | 8.9 | 22.45 | 8.6 | 23.24 |
| Sugar | 10.1 | 25.48 | 10.1 | 25.47 | 9.3 | 25.13 |
| Gingerbread spices, | 0 | 0.00 | 0 | 0.00 | 0.4 | 1.08 |
| ground | | | | | | |
| Whole egg, | 9.13 | 23.03 | 9.14 | 23.05 | 8.4 | 22.70 |
| pasteurised | | | | | | |
| Flavoring | 0.1 | 0.25 | 0.1 | 0.25 | 0.1 | 0.27 |
| Whole egg powder | 0 | 0.00 | 0 | 0.00 | 0 | 0.00 |
| Salt | 0.21 | 0.53 | 0.21 | 0.53 | 0.21 | 0.57 |
| Peanut butter | 0 | 0.00 | 1.2 | 3.03 | 0 | 0.00 |
| Almond flour | 1.2 | 3.03 | 0 | 0.00 | 0 | 0.00 |
| Wheat flour | 10 | 25.23 | 10 | 25.22 | 10 | 27.02 |
| Butter | 0 | 0.00 | 0 | 0.00 | 0 | 0.00 |
| Total | 39.64 | 100 | 39.65 | 100 | 37.01 | 100 |

Baking masses F: shorter texture/better flavor - variants 5

| | Full-cream milk | | Skimmed milk | | Skimmed milk | |
|---|---|---|---|---|---|---|
| | A | | A | | C | |
| Raw materials | kg/lb | % | kg/lb | % | kg/lb | % |
| Water | 15.2 | 39.83 | 15.2 | 39.80 | 15 | 39.66 |
| Sugar colour | 0 | 0.00 | 0 | 0.00 | 0 | 0.00 |
| Invert sugar | 0 | 0.00 | 0 | 0.00 | 0 | 0.00 |
| Sugar | 9.6 | 25.16 | 9.6 | 25.14 | 9.5 | 25.12 |
| Whole egg, | 0 | 0.00 | 0 | 0.00 | 0 | 0.00 |
| pasteurised | | | | | | |
| Flavoring | 0.1 | 0.26 | 0.1 | 0.26 | 0.1 | 0.26 |
| Whole egg | 1.81 | 4.74 | 1.805 | 4.73 | 1.49 | 3.94 |
| powder | | | | | | |
| Salt | 0.21 | 0.55 | 0.21 | 0.55 | 0.21 | 0.56 |
| Full-cream | 1.243 | 3.26 | 0 | 0.00 | 0 | 0.00 |
| milk powder | | | | | | |
| Skimmed | 0 | 0.00 | 0.926 | 2.42 | 1.02 | 2.70 |
| milk powder | | | | | | |
| Wheat flour | 10 | 26.20 | 10 | 26.18 | 10 | 26.44 |
| Butter | 0 | 0.00 | 0.35 | 0.92 | 0.5 | 1.32 |
| Total | 38.163 | 100 | 38.191 | 100 | 37.82 | 100 |

Baking masses G: shorter texture/better flavor - variants 6

| | Full-cream milk | | Skimmed milk | | Skimmed milk | |
|---|---|---|---|---|---|---|
| | A | | A | | C | |
| Raw materials | kg | % | kg | % | kg | % |
| Water | 10.5 | 27.52 | 10.5 | 27.50 | 11.1 | 29.37 |
| Sugar colour | 0 | 0.00 | 0 | 0.00 | 0 | 0.00 |
| Invert sugar | 0 | 0.00 | 0 | 0.00 | 0 | 0.00 |
| Sugar | 9.6 | 25.16 | 9.6 | 25.14 | 9.5 | 25.14 |
| Whole egg | 6.5 | 17.04 | 6.5 | 17.02 | 5.36 | 14.18 |
| pasteurised | | | | | | |
| Flavoring | 0.1 | 0.26 | 0.1 | 0.26 | 0.1 | 0.26 |
| Whole egg | 0 | 0.00 | 0 | 0.00 | 0 | 0.00 |
| powder | | | | | | |
| Salt | 0.21 | 0.55 | 0.21 | 0.55 | 0.21 | 0.56 |
| Full-cream | 1.242 | 3.26 | 0 | 0.00 | 0 | 0.00 |
| milk powder | | | | | | |
| Skimmed | 0 | 0.00 | 0.926 | 2.42 | 1.02 | 2.70 |
| milk powder | | | | | | |
| Wheat flour | 10 | 26.21 | 10 | 26.19 | 10 | 26.46 |
| Butter | 0 | 0.00 | 0.35 | 0.92 | 0.5 | 1.32 |
| Total | 38.152 | 100 | 38.186 | 100 | 37.79 | 100 |

Baking masses H: shorter texture/better flavor - variants 7

| | Soya flour | | Whey protein | | Lupin flour | |
|---|---|---|---|---|---|---|
| Raw materials | kg | % | kg | % | kg | % |
| Water | 10.75 | 28.04 | 14.3 | 39.5 | 10.75 | 28.04 |
| Soya flour, toasted | 1.2 | 3.13 | 0 | 0.00 | 0 | 0.00 |
| Lupin flour, toasted | 0 | 0.00 | 0 | 0.00 | 1.2 | 3.13 |
| Sugar | 9.6 | 25.04 | 9.1 | 25.14 | 9.6 | 25.04 |
| Whole egg | 6.48 | 16.90 | 0 | 0.00 | 6.48 | 16.90 |
| pasteurised | | | | | | |
| Flavoring | 0.1 | 0.26 | 0.1 | 0.28 | 0.1 | 0.26 |
| Whole egg powder | 0 | 0.00 | 0 | 0.00 | 0 | 0.00 |
| Salt | 0.21 | 0.55 | 0.2 | 0.55 | 0.21 | 0.55 |
| Full-cream milk | 0 | 0.00 | 0 | 0.00 | 0 | 0.00 |
| powder | | | | | | |
| Whey protein | 0 | 0.00 | 1.5 | 4.14 | 0 | 0.00 |
| concentrate | | | | | | |
| Wheat flour | 10 | 26.08 | 10 | 27.63 | 10 | 26.08 |
| Butter fat | 0 | 0.00 | 1 | 2.76 | 0 | 0.00 |
| Total | 38.34 | 100 | 36.2 | 100 | 38.34 | 100 |

The baking masses A have an egg fraction of about 10% to about 50%. This results in a better taste and makes the baked products amenable to shortening by the shortening agent, e.g. by fat—i.e. shortenable.

The baking masses B also have an egg fraction of about 10% to about 50%. This results in a better taste and makes the baked products amenable to shortening by the shortening agent, e.g. by fat.

The baking masses C have as ingredients among others cocoa powder, coconut cream or coffee. These together with the egg fraction result in a better taste and make the baked products amenable to shortening by the shortening agent, e.g. by fat.

The baking masses D have as ingredients among others cocoa powder, coconut cream or coffee. These together with the egg fraction result in a better taste and make the baked products amenable to shortening by the shortening agent, e.g. by fat.

The baking masses E1 and E2 have as ingredients among others almond flour, peanut paste or gingerbread spice. These together with the egg fraction result in a better taste and make the baked products amenable to shortening by the shortening agent, e.g. by fat.

The baking masses F comprise in one embodiment full-cream milk, in other embodiments skimmed milk. These together with the egg fraction result in a better taste and make the baked products amenable to shortening by the shortening agent, e.g. by fat.

The baking masses G again comprise full-cream milk or skimmed milk. These together with the egg fraction result in a better taste and make the baked products amenable to shortening by the shortening agent, e.g. by fat.

The baking masses H comprise soya flour or lupin flour. These together with the egg fraction or the whey protein fraction result in a better taste and make the baked products amenable to shortening by the shortening agent, e.g. by fat. One embodiment dispenses with an egg fraction and uses whey protein concentrate as flavoring agent and shortening promoter. This embodiment of the baking mass is therefore free from egg fractions.

Preferred embodiments to achieve a delicate short texture after the greasing or after bringing in contact with the shortening agent contain an egg fraction between 25% and 42%, in particular 32% to 40%. These percentage details are understood as fresh egg content relative to end product in accordance with the usual QUID regulation in the EU. For this purpose egg powder fractions are accordingly converted to fresh egg.

Other flavoring non-high-starch raw materials in the baking mass, possibly milk-based components such as, for example, milk powder, skimmed milk powder, whey powder, soya flours, lupin flours as well as nut flours such as almonds, walnuts, hazelnuts, peanuts or other flavoring components such as coffee, cocoa powder, chocolate, coconut milk, tea or tea extracts, ginger and other spices or seasonings can reduce the egg fraction in an aliquot manner.

The following high-fat and/or oil-containing substances can be given as exemplary shortening agents:

| | Melting point ° C. | |
|---|---|---|
| Pure butter fat, | 30-32 | |
| melted | | |
| Butter oil | 5-10 | Butter olein |
| Butter, melted | 30 | |
| Vegetable | 32 | |
| margarine, melted | | |
| Milk margarine, | 31 | |
| melted | | |
| Lard | 34 | |
| Coconut oil | 24 | |
| Coconut oil, | | Coconut flavor |
| flavoured | | 0.2% |
| Coconut oil, | 32 | |
| hardened | | |
| Palm olein | 19-20 | |
| Palm olein, | 19-20 | Butter flavor, |
| flavoured | | fat-soluble 0.15% |

These shortening agents are used on the one hand for adjusting the taste and on the other hand for shortening the roll wafers.

Variable fractions of the shortening agent are filled into the hollow tube formed, for example, as infusion mass during rolling. This is then cut into pieces.

For fractions of infusion mass or shortening agent exceeding about 40 to 45% of the weight of the baked roll wafers, it is advantageous to keep the infused hollow tubes in a modified wafer tube elevator in a rolling movement in the first cooling phase in order to ensure a homogeneous penetration into the baking body. The introduction of mixtures of the said infusion masses or shortening agents is also provided.

According to the prior art three comparative examples VA, VB and VC are given which expressly are not suitable to be used in the method according to the invention. The reason for this is the non-given shortness of the product obtained in each case.

### BAKING MASSES

### Comparative Examples

| | EP 1437045 A1 | | WO 2000005966 A1, | |
|---|---|---|---|---|
| | Example 1 | | Recipe No. 1 | |
| Raw materials | kg/lb | % | kg/lb | % |
| Water | 40 | 40 | 130 | 41.11 |
| Lecithin powder | 0 | 0.00 | 0.5 | 0.16 |
| Invert sugar | 0 | 0.00 | 0 | 0.00 |
| Sugar | 23 | 23 | 70 | 22.14 |
| Whole egg, pasteurised | 0 | 0.00 | 0 | 0.00 |
| Lecithin, liquid | 0.4 | 0.4 | 0.2 | 0.06 |
| Cocoa powder | 0.4 | 0.4 | 0 | 0 |
| Salt | 0.2 | 0.2 | 0 | 0 |
| Skimmed milk powder | 2 | 2 | 5 | 1.58 |
| Starch | 0 | 0 | 10 | 3.16 |
| Wheat flour | 32 | 32 | 100 | 31.63 |
| Hard fat | 2 | 2 | 0 | 0 |
| Vegetable oil | 0 | 0 | 0.5 | 0.16 |
| Total | 100 | 100 | 316.2 | 100 |

### Comparative Example VA

the texture after baking, rolling and cooling without infusion is crispy hard, typical. The texture after baking, rolling and cooling with infusion is also crispy hard. There is no shortening of the texture.

### Comparative Example VB

the texture after baking, rolling and cooling without infusion is crispy hard, typical. The texture after baking, rolling and cooling with infusion is also crispy hard—there is no shortening of the texture.

Comparative example VC corresponds to baking mass VA with 40% egg fraction. The texture after baking, rolling and cooling without infusion is crispy hard, typical.

Consequently, in baking masses VA, VB which correspond to the prior art, no shortening is achieved even by an infusion of fats.

Comparative example VC again shows that a baking mass according to the invention with an egg fraction alone without adding shortening agents has no short texture.

According to the invention, it is provided that the roll wafer recipe contains additional non-high-starch components from the group of protein-rich raw materials possibly based on egg, milk, vegetable proteins or from the group of other non-high-starch raw materials such as possibly cocoa powder, nut flours, which make the baked and rolled roll wafer body amenable to shortening by fats. This is in contrast to the recipes of the comparative examples which have too-small fractions of substances which make the crispy-hard starch-sugar matrix of conventional roll wafers amenable to shortening by fats.

The method according to the invention is explained further subsequently.

A flowable baking mass is metered and/or applied to a continuously moving heated baking surface in a thin layer, forming an endless dough strip which becomes a largely dry-baked endless baked strip until it is removed from the baking surface.

The still-hot baked strip is released from the baking surface, optionally with the aid of a scraper knife, but is preferably removed continuously by pulling off the plastically soft and sufficiently tensile strip by drawing into a rolling apparatus.

The plastic strip is shaped by means of a roll mandrel having a central bore to form an endless hollow tube or an endless roll wafer in which a shortening agent, e.g. a fat in adjustable quantitative ratio is introduced at the same time, subsequently and/or simultaneously.

The shortening agent corresponds to or comprises, e.g. an oil, a high-fat emulsion in liquid form, a fat and/or a high-fat emulsion which is liquefied by melting.

Optionally, the properties of the end product can be additionally influenced by spraying-on a water-based solution. A watery solution is sprayed onto the upstream side of the baked wafer strip. i.e. the side which lies on the “front side” of the endless roll which is formed, directly before rolling. The solution fractions supplied are small from the quantitative viewpoint and lead to a maximum increase in the residual moisture of the rolled short wafer of less than/equal to 0.2%.

Exemplary compositions of the water-based spray solutions are:
1. Water for improved sealing of the turns of the wound baked strip,
2. Syrup solution of, for example, 10 to 25% glucose syrup, invert sugar syrup, fructose syrup or honey in water for improved sealing and/or adhesion of the turns of the wound baked strip as well as
3. one of the two solutions 1 or 2 with additional water-based flavorings for improved sealing and/or adhesion of the turns of the wound baked strip, and additional flavoring.

The endless wafer tube or the endless roll wafer is then divided into pieces which are moved further horizontally and/or along the principal direction of extension of the roll wafers until the first drawing of the liquid fat phase of the shortening agent into the wafer body.

Alternatively or additionally, the roller wafers can be processed and/or reshaped after or during the cutting by process steps such as pressing, stamping, embossing or forming of laterally sealed cushion-shape roll wafer products.

Drawing in the liquid fat phase of the shortening agent is understood as the state where during a rotation of the roll wafer from the horizontal position no more liquid drops of fat flow away. This point depends on the metered amount of liquid fat applied relative to the inner surface or to the weight of the roll wafer. Experience shows that fractions of less than about 20% of the roll wafer weight are drawn in very rapidly and do not require any longer holding horizontally. For metered amounts above about 50% of the roll wafer weight, a rotating horizontal movement of the roll wafer body is certainly advantageous since it shortens the time of the horizontal conveying but is not absolutely necessary.

Alternatively the shortening agent or the quantity of liquid fat for shortening can also be applied by means of an external metering or application such as, for example, by brushing or spraying through a pouring curtain after or before the cutting or reshaping.

The finished and cooled short baked items are then packaged immediately to protect against ingress of moisture, oxygen from the air and for hygiene reasons.

It should also be noted that the short texture relates to the finished end product. This consists of or comprises:
a-non-short sufficiently firmly baked roll wafer which, from outside or preferably from inside,
is impregnated, brushed, sprayed, coated or filled with a substance from the group of fats and high-fat emulsions in order to then
form the short end product according to the invention after extensive distribution in the roll wafer body. It should expressly be noted that in contrast to conventional short baked goods, an isotropic, homogeneous distribution of the fats in the body of the baked goods should not be assumed here. Sufficient strength exists if the baked strip baked from the baking mass can be baked and rolled on a conventional annular baking machine.

Consequently, the desired short texture is only achieved by the shortening agent. Preferably defined as a shortenable baking mass is a baking mass which after baking has a non-short texture but which is shortenable by the shortening agents according to the invention. This non-short texture can only be determined in the cooled state.

The thickness of the baked roll wafer strip is preferably greater than in conventional hollow wafer tube strips but also includes their usual thicknesses and is between 0.5 and 1.3 mm, preferably 0.7 to 1.1 mm. An advantage of the thicker configuration of the roll wafer strip is the higher strength during removal and rolling. In addition, a somewhat increased porosity was determined which positively influences the eating behaviour in delicate-short direction.

The plastically soft condition in the hot state is brought about by melted carbohydrates. This is preferably saccharose but other substances which plasticize the baked strip in the hot state can be considered as proportional, possibly complete replacements for saccharose. This group comprises other sugar substances such as glucose, fructose, maltose, lactose as well as syrups containing these components as well as sugar replacement substances such as isomalt (Palatinit), polydextrose, as well as plasticizing polyols such as, for example, erythrite, maltite or xylite or syrups containing such polyols. All these substances have a plasticizing effect in the hot state. This is required for the rollability of the ready-baked roll wafer strip as well as any pressing, stamping or embossing processes in the still-hot state.

The fats of the shortening agents preferably comprise two groups:

Firstly: oils which are liquid at room temperature and melted fats preferably having a solidification point below about 37° C., in particular below about 33° C.

And/or secondly: high-fat emulsions from the group of butter and margarines having a fat content of over 50%, preferably of over 80%. The quantities of moisture introduced via the metered shortening fat fractions must not result in an increase in the total moisture of the finished short roll wafers above 7%, preferably above 5%.

The shortening agents in both these groups can optionally be provided with an additional flavoring.

According to one embodiment of the method according to the invention, the step of baking the roll wafer strip is separated from the introduction of fat into the system for shortening purposes.

A shortening oil or melted fat fraction is only introduced into the ready-baked roll wafer, preferably by impregnation from inside.

According to another embodiment of the method according to the invention, the hardening effect of higher sugar fractions is neutralized or compensated by increased fractions of proteins which originate from egg, milk, soya or other high-protein components. In this way, the high-sugar-substance basic composition required for the rollability can be made amenable to the shortening effect of fats in an advantageous manner. The use of higher protein fractions is explained in detail in the exemplary embodiments for the example of (chicken) egg fractions. A comparable effect and an equivalent property can be achieved by substitution or partial substitution with other proteins, possibly based on milk, soya, or other vegetable or animal protein sources.

Another embodiment of the method according to the invention comprises the following steps: a shortenable baking mass is applied to a moving, heated baking surface to form an endless baked strip; the baked strip in the hot plastic state is then removed at least partially from the baking surface and fed to a rolling apparatus; where the baked strip is wound around a roll mandrel in the rolling apparatus and formed into an endless hollow tube; and where the baked strip and/or the hollow tube is filled, brushed, coated, sprayed and/or brought in contact with a shortening agent for shortening at the same time, before or afterwards.

As preferred compositions, the baking masses have the following quantitative details relative to 100 parts of flour or high-starch flours:

sugar: 65 to 105, preferably 75 to 100

fat: less than 14, preferably less than 8, particularly preferably less than 6.5

whole egg: 18 to 112, preferably 38 to 112.

Proteins: in addition to egg proteins from the said egg fraction, other animal or vegetable proteins can serve as a replacement or partial replacement for the egg protein.

As a result of the method according to the invention and the composition of the baking masses according to the invention and the shortening agents, it is possible to produce roll wafers having a short texture on conventional apparatus for the continuous production of roll wafers. To this end, as described, a shortenable, baked baking mass which is sufficiently firm for winding in the baked state is additionally brought into contact with a shortening agent in order to obtain an end product having a short texture. It is thus possible to produce roll wafers having a short texture with an existing ring baking machines which is preferably suitable for carrying out a filling or a coating of continuously produced roll wafers. A new method is thereby executed on a substantially known baking machine. This comprises the steps which are disclosed in the description and in the patent claims. In particular this comprises the combination of the baking masses listed in the description with the listed shortening agents and their use in the method according to the invention. The invention further relates to the use of the listed or similar baking masses and/or the listed or similar shortening agents for the continuous production of roll wafers.

1-20. (canceled)

21. A method for the continuous production of roll wafers having a short texture, the method comprising the following steps:
a) applying a shortenable baking mass to a moving heated baking surface to form an endless baked strip;
b) baking the baked strip substantially dry during the movement of the heated baking surface;
c) then at least partially removing the baked strip in a hot plastic state from the baking surface and feeding the baked strip to a rolling apparatus;
d) winding the baked strip around a rolling mandrel in the rolling apparatus and forming the baked strip into an endless hollow tube; and
e) at least one of filling, brushing, coating, spray-coating or bringing at least one of the baked strip or the hollow tube into contact with a shortening agent for shortening at the same time, before or after the winding step.

22. The method according to claim 21, which further comprises reshaping the hollow tube.

23. The method according to claim 22, which further comprises carrying out the reshaping step by at least one of pressing, stamping, cutting, dividing into pieces, embossing or sealing by compressing lateral cut ends.

24. The method according to claim 21, which further comprises moving the hollow tube or the baked strip at least one of along its principal direction of extension or in a horizontal direction after applying the shortening agent, until the shortening agent is incorporated.

25. The method according to claim 24, which further comprises rotating the hollow tube or the baked strip simultaneously with the step of moving the hollow tube or the baked strip.

26. The method according to claim 21, which further comprises providing the baking mass with the following ingredients relative to 100 parts of at least one of flour or high-starch flours:
a) sugar: 65 to 105 parts or 75 to 100 parts;
b) fat: less than 14 parts, less than 8 parts or less than 6.5 parts; and
c) whole egg: 18 to 112 parts or 38 to 112 parts or equivalent quantities of animal or vegetable proteins serving as a replacement for egg protein.

27. The method according to claim 21, which further comprises providing the baking mass with ingredients lying in a range of ingredients of baking masses A, baking masses B, baking masses C, baking masses D, baking masses E1, baking masses E2, baking masses F, baking masses G or baking masses H:
Baking masses A

| | 50% egg | | 45% egg | | 40% egg | |
|---|---|---|---|---|---|---|
| | fraction | | fraction | | fraction | |
| Raw materials | kg | % | kg | % | kg | % |
| Water | 15.4 | 39.47 | 15.1 | 39.61 | 14.75 | 39.61 |
| Sugar | 10 | 25.63 | 9.7 | 25.45 | 9.375 | 25.18 |
| Butter-vanilla | 0.1 | 0.26 | 0.1 | 0.26 | 0.1 | 0.27 |
| flavoring | | | | | | |
| Whole egg powder | 3.095 | 7.93 | 2.71 | 7.11 | 2.35 | 6.31 |
| Whole egg, | 0 | 0.00 | 0 | 0.00 | 0 | 0.00 |
| pasteurized | | | | | | |
| Salt | 0.22 | 0.56 | 0.21 | 0.55 | 0.21 | 0.56 |
| Wheat flour | 10 | 25.63 | 10 | 26.23 | 10 | 26.86 |
| Butter fat | 0.2 | 0.51 | 0.3 | 0.79 | 0.45 | 1.21 |
| Total | 39.015 | 100 | 38.72 | 100 | 37.235 | 100 |
| | 35% egg | | 30% egg | | 25% egg | |
|---|---|---|---|---|---|---|
| | fraction | | fraction | | fraction | |
| Raw materials | kg | % | kg | % | kg | % |
| Water | 14.45 | 39.69 | 14.1 | 39.70 | 14.5 | 40.97 |
| Sugar | 9.06 | 24.88 | 8.7 | 24.50 | 8.45 | 23.87 |
| Butter-vanilla | 0.1 | 0.27 | 0.1 | 0.28 | 0.1 | 0.28 |
| flavoring | | | | | | |
| Whole egg powder | 2 | 5.49 | 1.67 | 4.70 | 1.356 | 3.83 |
| Whole egg, | 0 | 0.00 | 0 | 0.00 | 0 | 0.00 |
| pasteurized | | | | | | |
| Salt | 0.2 | 0.55 | 0.195 | 0.55 | 0.19 | 0.54 |
| Wheat flour | 10 | 27.46 | 10 | 28.16 | 10 | 28.25 |
| Butter fat | 0.6 | 1.65 | 0.75 | 2.11 | 0.8 | 2.26 |
| Total | 36.41 | 100 | 35.515 | 100 | 35.396 | 100 |
| | 20% egg | | 15% egg | | 10% egg | |
| | fraction | | fraction | | fraction | |
| Raw materials | kg | % | kg | % | kg | % |
| Water | 13.55 | 39.87 | 13.1 | 40.01 | 13 | 40.03 |
| Sugar | 8.1 | 23.83 | 7.8 | 23.82 | 7.5 | 23.09 |
| Butter-vanilla | 0.1 | 0.29 | 0.1 | 0.31 | 0.1 | 0.31 |
| flavoring | | | | | | |
| Whole egg powder | 1.055 | 3.10 | 0.76 | 2.32 | 0.5 | 1.54 |
| Whole egg, | 0 | 0.00 | 0 | 0.00 | 0 | 0.00 |
| pasteurized | | | | | | |
| Salt | 0.18 | 0.53 | 0.18 | 0.55 | 0.175 | 0.54 |
| Wheat flour | 10 | 29.42 | 10 | 30.54 | 10 | 30.79 |
| Butter fat | 1 | 2.94 | 0.8 | 2.44 | 1.2 | 3.70 |
| Total | 33.985 | 100 | 32.74 | 100 | 32.475 | 100 |

Baking masses B:

| | 50% egg | | 45% egg | | 40% egg | |
|---|---|---|---|---|---|---|
| | fraction | | fraction | | fraction | |
| Raw materials | kg | % | kg | % | kg | % |
| Water | 7.3 | 18.74 | 8 | 21.01 | 8.6 | 23.13 |
| Sugar | 10 | 25.67 | 9.7 | 25.48 | 9.375 | 25.21 |
| Butter-vanilla | 0.1 | 0.26 | 0.1 | 0.26 | 0.1 | 0.27 |
| flavoring | | | | | | |
| Whole egg powder | 0 | 0.00 | 0 | 0.00 | 0 | 0.00 |
| Whole egg, | 11.14 | 28.59 | 9.76 | 25.64 | 8.45 | 22.72 |
| pasteurized | | | | | | |
| Salt | 0.22 | 0.56 | 0.21 | 0.55 | 0.21 | 0.56 |
| Wheat flour | 10 | 25.67 | 10 | 26.27 | 10 | 26.89 |
| Butter fat | 0.2 | 0.51 | 0.3 | 0.79 | 0.45 | 1.21 |
| Total | 38.96 | 100 | 38.07 | 100 | 37.185 | 100 |
| | 35% egg | | 30% egg | | 25% egg | |
| | fraction | | fraction | | fraction | |
| Raw materials | kg | % | kg | % | kg | % |
| Water | 9.2 | 25.20 | 9.75 | 27.47 | 10.95 | 30.96 |
| Sugar | 9.06 | 24.92 | 8.7 | 24.51 | 8.45 | 23.89 |
| Butter-vanilla | 0.1 | 0.28 | 0.1 | 0.28 | 0.1 | 0.28 |
| flavoring | | | | | | |
| Whole egg powder | 0 | 0.00 | 0 | 0.00 | 0 | 0.00 |
| Whole egg, | 7.2 | 19.80 | 6 | 16.90 | 4.88 | 13.80 |
| pasteurized | | | | | | |
| Salt | 0.2 | 0.55 | 0.195 | 0.55 | 0.19 | 0.54 |
| Wheat flour | 10 | 27.50 | 10 | 28.17 | 10 | 28.27 |
| Butter fat | 0.6 | 1.65 | 0.75 | 2.11 | 0.8 | 2.26 |
| Total | 36.36 | 100 | 35.495 | 100 | 35.37 | 100 |
| | 20% egg | | 15% egg | | 10% egg | |
| | fraction | | fraction | | fraction | |
| Raw materials | kg | % | kg | % | kg | % |
| Water | 11 | 32.18 | 11.1 | 33.92 | 11.7 | 36.03 |
| Sugar | 8.1 | 23.70 | 7.8 | 23.84 | 7.5 | 23.09 |
| Butter-vanilla | 0.1 | 0.29 | 0.1 | 0.31 | 0.1 | 0.31 |
| flavoring | | | | | | |
| Whole egg powder | 0 | 0.00 | 0 | 0.00 | 0 | 0.00 |
| Whole egg, | 3.8 | 11.12 | 2.74 | 8.37 | 1.8 | 5.54 |
| pasteurized | | | | | | |
| Salt | 0.18 | 0.53 | 0.18 | 0.55 | 0.175 | 0.54 |
| Wheat flour | 10 | 29.26 | 10 | 30.56 | 10 | 30.79 |
| Butter fat | 1 | 2.93 | 0.8 | 2.44 | 1.2 | 3.70 |
| Total | 34.18 | 100 | 32.72 | 100 | 32.475 | 100 |

Baking masses C:

| | Cocoa A | | Coconut A | | Coffee A | |
|---|---|---|---|---|---|---|
| Raw materials | kg | % | kg | % | kg | % |
| Water | 15.1 | 40.46 | 14.1 | 37.54 | 15 | 39.16 |
| Sugar color | 0.1 | 0.27 | 0 | 0.00 | 0 | 0.00 |
| Sugar | 9.3 | 24.92 | 9.55 | 25.43 | 9.75 | 25.46 |
| Coffee, roasted | 0 | 0.00 | 0 | 0.00 | 0.4 | 1.04 |
| ground | | | | | | |
| Coconut cream | 0 | 0.00 | 1.2 | 3.20 | 0 | 0.00 |
| Cocoa powder | 0.4 | 1.07 | 0 | 0.00 | 0 | 0.00 |
| Flavoring | 0.1 | 0.27 | 0.1 | 0.27 | 0.1 | 0.26 |
| Whole | 2.325 | 6.23 | 2.395 | 6.38 | 2.44 | 6.37 |
| egg powder | | | | | | |
| Salt | 0.2 | 0.54 | 0.21 | 0.56 | 0.21 | 0.55 |
| Wheat flour | 9.6 | 25.72 | 10 | 26.63 | 10 | 26.11 |
| Butter | 0.2 | 0.54 | 0 | 0.00 | 0.4 | 1.04 |
| Total | 37.325 | 100 | 37.555 | 100 | 38.3 | 100 |

Baking masses D:

| | Cocoa B | | Coconut B | | Coffee B | |
|---|---|---|---|---|---|---|
| Raw materials | kg | % | kg | % | kg | % |
| Water | 9 | 24.1 | 7.9 | 21.03 | 8.6 | 22.45 |
| Sugar color | 0.1 | 0.27 | 0 | 0.00 | 0 | 0.00 |
| Sugar | 9.3 | 24.95 | 9.55 | 25.43 | 9.75 | 25.45 |
| Coffee, roasted | 0 | 0.00 | 0 | 0.00 | 0.4 | 1.04 |
| ground | | | | | | |
| Coconut cream | 0 | 0.00 | 1.2 | 3.19 | 0 | 0.00 |
| Cocoa powder | 0.4 | 1.07 | 0 | 0.00 | 0 | 0.00 |
| Whole egg, | 8.37 | 22.46 | 8.6 | 22.90 | 8.8 | 22.97 |
| pasteurized | | | | | | |
| Flavoring | 0.1 | 0.27 | 0.1 | 0.27 | 0.1 | 0.26 |
| Salt | 0.2 | 0.54 | 0.21 | 0.56 | 0.21 | 0.55 |
| Wheat flour | 9.6 | 25.76 | 10 | 26.62 | 10 | 26.10 |
| Butter | 0.2 | 0.54 | 0 | 0.00 | 0.45 | 1.17 |
| Total | 37.27 | 100 | 37.56 | 100 | 38.31 | 100 |

Baking masses E1:

| | Almond A | | Peanut A | | Gingerbread A | |
|---|---|---|---|---|---|---|
| Raw materials | kg | % | kg | % | kg | % |
| Water | 15.5 | 39.09 | 15.5 | 39.09 | 14.7 | 39.68 |
| Sugar | 10.1 | 25.47 | 10.1 | 25.47 | 9.3 | 25.10 |
| Gingerbread spices, | 0 | 0.00 | 0 | 0.00 | 0.4 | 1.08 |
| ground | | | | | | |
| Flavoring | 0.1 | 0.25 | 0.1 | 0.25 | 0.1 | 0.27 |
| Whole egg powder | 2.54 | 6.41 | 2.54 | 6.41 | 2.34 | 6.32 |
| Salt | 0.21 | 0.53 | 0.21 | 0.53 | 0.21 | 0.57 |
| Peanut butter | 0 | 0.00 | 1.2 | 3.03 | 0 | 0.00 |
| Almond flour | 1.2 | 3.03 | 0 | 0.00 | 0 | 0.00 |
| Wheat flour | 10 | 25.22 | 10 | 25.22 | 10 | 26.99 |
| Butter | 0 | 0.00 | 0 | 0.00 | 0 | 0.00 |
| Total | 39.65 | 100 | 39.65 | 100 | 37.05 | 100 |

Baking masses E2:

| | Almond B | | Peanut B | | Gingerbread B | |
|---|---|---|---|---|---|---|
| Raw materials | kg | % | kg | % | kg | % |
| Water | 8.9 | 22.45 | 8.9 | 22.45 | 8.6 | 23.24 |
| Sugar | 10.1 | 25.48 | 10.1 | 25.47 | 9.3 | 25.13 |
| Gingerbread spices, | 0 | 0.00 | 0 | 0.00 | 0.4 | 1.08 |
| ground | | | | | | |
| Whole egg, | 9.13 | 23.03 | 9.14 | 23.05 | 8.4 | 22.70 |
| pasteurized | | | | | | |
| Flavoring | 0.1 | 0.25 | 0.1 | 0.25 | 0.1 | 0.27 |
| Whole egg powder | 0 | 0.00 | 0 | 0.00 | 0 | 0.00 |
| Salt | 0.21 | 0.53 | 0.21 | 0.53 | 0.21 | 0.57 |
| Peanut butter | 0 | 0.00 | 1.2 | 3.03 | 0 | 0.00 |
| Almond flour | 1.2 | 3.03 | 0 | 0.00 | 0 | 0.00 |
| Wheat flour | 10 | 25.23 | 10 | 25.22 | 10 | 27.02 |
| Butter | 0 | 0.00 | 0 | 0.00 | 0 | 0.00 |
| Total | 39.64 | 100 | 39.65 | 100 | 37.01 | 100 |

Baking masses F:

| | Full-cream | | Skimmed | | Skimmed | |
|---|---|---|---|---|---|---|
| | milk A | | milk A | | milk C | |
| Raw materials | kg/lb | % | kg/lb | % | kg/lb | % |
| Water | 15.2 | 39.83 | 15.2 | 39.80 | 15 | 39.66 |
| Sugar color | 0 | 0.00 | 0 | 0.00 | 0 | 0.00 |
| Invert sugar | 0 | 0.00 | 0 | 0.00 | 0 | 0.00 |
| Sugar | 9.6 | 25.16 | 9.6 | 25.14 | 9.5 | 25.12 |
| Whole egg, | 0 | 0.00 | 0 | 0.00 | 0 | 0.00 |
| pasteurized | | | | | | |
| Flavoring | 0.1 | 0.26 | 0.1 | 0.26 | 0.1 | 0.26 |
| Whole egg | 1.81 | 4.74 | 1.805 | 4.73 | 1.49 | 3.94 |
| powder | | | | | | |
| Salt | 0.21 | 0.55 | 0.21 | 0.55 | 0.21 | 0.56 |
| Full-cream milk | 1.243 | 3.26 | 0 | 0.00 | 0 | 0.00 |
| powder | | | | | | |
| Skimmed milk | 0 | 0.00 | 0.926 | 2.42 | 1.02 | 2.70 |
| powder | | | | | | |
| Wheat flour | 10 | 26.20 | 10 | 26.18 | 10 | 26.44 |
| Butter | 0 | 0.00 | 0.35 | 0.92 | 0.5 | 1.32 |
| Total | 38.163 | 100 | 38.191 | 100 | 37.82 | 100 |

Baking masses G:

| | Full-cream | | Skimmed | | Skimmed | |
|---|---|---|---|---|---|---|
| | milk A | | milk A | | milk C | |
| Raw materials | kg | % | kg | % | kg | % |
| Water | 10.5 | 27.52 | 10.5 | 27.50 | 11.1 | 29.37 |
| Sugar color | 0 | 0.00 | 0 | 0.00 | 0 | 0.00 |
| Invert sugar | 0 | 0.00 | 0 | 0.00 | 0 | 0.00 |
| Sugar | 9.6 | 25.16 | 9.6 | 25.14 | 9.5 | 25.14 |
| Whole egg | 6.5 | 17.04 | 6.5 | 17.02 | 5.36 | 14.18 |
| pasteurized | | | | | | |
| Flavoring | 0.1 | 0.26 | 0.1 | 0.26 | 0.1 | 0.26 |
| Whole egg | 0 | 0.00 | 0 | 0.00 | 0 | 0.00 |
| powder | | | | | | |
| Salt | 0.21 | 0.55 | 0.21 | 0.55 | 0.21 | 0.56 |
| Full-cream milk | 1.242 | 3.26 | 0 | 0.00 | 0 | 0.00 |
| powder | | | | | | |
| Skimmed milk | 0 | 0.00 | 0.926 | 2.42 | 1.02 | 2.70 |
| powder | | | | | | |
| Wheat flour | 10 | 26.21 | 10 | 26.19 | 10 | 26.46 |
| Butter | 0 | 0.00 | 0.35 | 0.92 | 0.5 | 1.32 |
| Total | 38.152 | 100 | 38.186 | 100 | 37.79 | 100 |

Baking masses H:

| | Soya flour | | Whey protein | | Lupin flour | |
|---|---|---|---|---|---|---|
| Raw materials | kg | % | kg | % | kg | % |
| Water | 10.75 | 28.04 | 14.3 | 39.5 | 10.75 | 28.04 |
| Soya flour, toasted | 1.2 | 3.13 | 0 | 0.00 | 0 | 0.00 |
| Lupin flour, toasted | 0 | 0.00 | 0 | 0.00 | 1.2 | 3.13 |
| Sugar | 9.6 | 25.04 | 9.1 | 25.14 | 9.6 | 25.04 |
| Whole egg | 6.48 | 16.90 | 0 | 0.00 | 6.48 | 16.90 |
| pasteurized | | | | | | |
| Flavoring | 0.1 | 0.26 | 0.1 | 0.28 | 0.1 | 0.26 |
| Whole egg powder | 0 | 0.00 | 0 | 0.00 | 0 | 0.00 |
| Salt | 0.21 | 0.55 | 0.2 | 0.55 | 0.21 | 0.55 |
| Full-cream milk | 0 | 0.00 | 0 | 0.00 | 0 | 0.00 |
| powder | | | | | | |
| Whey protein | 0 | 0.00 | 1.5 | 4.14 | 0 | 0.00 |
| concentrate | | | | | | |
| Wheat flour | 10 | 26.08 | 10 | 27.63 | 10 | 26.08 |
| Butter fat | 0 | 0.00 | 1 | 2.76 | 0 | 0.00 |
| Total | 38.34 | 100 | 36.2 | 100 | 38.34 | 100 |

28. The method according to claim 21, wherein the baking mass substantially corresponds to one of baking masses A, baking masses B, baking masses C, baking masses D, baking masses E1, baking masses E2, baking masses F, baking masses G or baking masses H:
Baking masses A

| | 50% | | 45% | | 40% | |
|---|---|---|---|---|---|---|
| | egg | | egg | | egg | |
| | fraction | | fraction | | fraction | |
| Raw materials | kg | % | kg | % | kg | % |
| Water | 15.4 | 39.47 | 15.1 | 39.61 | 14.75 | 39.61 |
| Sugar | 10 | 25.63 | 9.7 | 25.45 | 9.375 | 25.18 |
| Butter-vanilla | 0.1 | 0.26 | 0.1 | 0.26 | 0.1 | 0.27 |
| flavoring | | | | | | |
| Whole egg | 3.095 | 7.93 | 2.71 | 7.11 | 2.35 | 6.31 |
| powder | | | | | | |
| Whole egg, | 0 | 0.00 | 0 | 0.00 | 0 | 0.00 |
| pasteurized | | | | | | |
| Salt | 0.22 | 0.56 | 0.21 | 0.55 | 0.21 | 0.56 |
| Wheat flour | 10 | 25.63 | 10 | 26.23 | 10 | 26.86 |
| Butter fat | 0.2 | 0.51 | 0.3 | 0.79 | 0.45 | 1.21 |
| Total | 39.015 | 100 | 38.12 | 100 | 37.235 | 100 |
| | 35% | | 30% | | 25% | |
| | egg | | egg | | egg | |
| | fraction | | fraction | | fraction | |
| Raw materials | kg | % | kg | % | kg | % |
| Water | 14.45 | 39.69 | 14.1 | 39.70 | 14.5 | 40.97 |
| Sugar | 9.06 | 24.88 | 8.7 | 24.50 | 8.45 | 23.87 |
| Butter-vanilla | 0.1 | 0.27 | 0.1 | 0.28 | 0.1 | 0.28 |
| flavoring | | | | | | |
| Whole egg | 2 | 5.49 | 1.67 | 4.70 | 1.356 | 3.83 |
| powder | | | | | | |
| Whole egg, | 0 | 0.00 | 0 | 0.00 | 0 | 0.00 |
| pasteurized | | | | | | |
| Salt | 0.2 | 0.55 | 0.195 | 0.55 | 0.19 | 0.54 |
| Wheat flour | 10 | 27.46 | 10 | 28.16 | 10 | 28.25 |
| Butter fat | 0.6 | 1.65 | 0.75 | 2.11 | 0.8 | 2.26 |
| Total | 36.41 | 100 | 35.515 | 100 | 35.396 | 100 |
| | 20% | | 15% | | 10% | |
| | egg | | egg | | egg | |
| | fraction | | fraction | | fraction | |
| Raw materials | kg | % | kg | % | kg | % |
| Water | 13.55 | 39.87 | 13.1 | 40.01 | 13 | 40.03 |
| Sugar | 8.1 | 23.83 | 7.8 | 23.82 | 7.5 | 23.09 |
| Butter-vanilla | 0.1 | 0.29 | 0.1 | 0.31 | 0.1 | 0.31 |
| flavoring | | | | | | |
| Whole egg | 1.055 | 3.10 | 0.76 | 2.32 | 0.5 | 1.54 |
| powder | | | | | | |
| Whole egg, | 0 | 0.00 | 0 | 0.00 | 0 | 0.00 |
| pasteurized | | | | | | |
| Salt | 0.18 | 0.53 | 0.18 | 0.55 | 0.175 | 0.54 |
| Wheat flour | 10 | 29.42 | 10 | 30.54 | 10 | 30.79 |
| Butter fat | 1 | 2.94 | 0.8 | 2.44 | 1.2 | 3.70 |
| Total | 33.985 | 100 | 32.74 | 100 | 32.475 | 100 |

Baking masses B:

| | 50% | | 45% | | 40% | |
|---|---|---|---|---|---|---|
| | egg | | egg | | egg | |
| | fraction | | fraction | | fraction | |
| Raw materials | kg | % | kg | % | kg | % |
| Water | 7.3 | 18.74 | 8 | 21.01 | 8.6 | 23.13 |
| Sugar | 10 | 25.67 | 9.7 | 25.48 | 9.375 | 25.21 |
| Butter-vanilla | 0.1 | 0.26 | 0.1 | 0.26 | 0.1 | 0.27 |
| flavoring | | | | | | |
| Whole egg | 0 | 0.00 | 0 | 0.00 | 0 | 0.00 |
| powder | | | | | | |
| Whole egg, | 11.14 | 28.59 | 9.76 | 25.64 | 8.45 | 22.72 |
| pasteurized | | | | | | |
| Salt | 0.22 | 0.56 | 0.21 | 0.55 | 0.21 | 0.56 |
| Wheat flour | 10 | 25.67 | 10 | 26.27 | 10 | 26.89 |
| Butter fat | 0.2 | 0.51 | 0.3 | 0.79 | 0.45 | 1.21 |
| Total | 38.96 | 100 | 38.07 | 100 | 37.185 | 100 |
| | 35% | | 30% | | 25% | |
| | egg | | egg | | egg | |
| | fraction | | fraction | | fraction | |
| Raw materials | kg | % | kg | % | kg | % |
| Water | 9.2 | 25.20 | 9.75 | 27.47 | 10.95 | 30.96 |
| Sugar | 9.06 | 24.92 | 8.7 | 24.51 | 8.45 | 23.89 |
| Butter-vanilla | 0.1 | 0.28 | 0.1 | 0.28 | 0.1 | 0.28 |
| flavoring | | | | | | |
| Whole egg | 0 | 0.00 | 0 | 0.00 | 0 | 0.00 |
| powder | | | | | | |
| Whole egg, | 7.2 | 19.80 | 6 | 16.90 | 4.88 | 13.80 |
| pasteurized | | | | | | |
| Salt | 0.2 | 0.55 | 0.195 | 0.55 | 0.19 | 0.54 |
| Wheat flour | 10 | 27.50 | 10 | 28.17 | 10 | 28.27 |
| Butter fat | 0.6 | 1.65 | 0.75 | 2.11 | 0.8 | 2.26 |
| Total | 36.36 | 100 | 35.495 | 100 | 35.37 | 100 |
| | 20% | | 15% | | 10% | |
| | egg | | egg | | egg | |
| | fraction | | fraction | | fraction | |
| Raw materials | kg | % | kg | % | kg | % |
| Water | 11 | 32.18 | 11.1 | 33.92 | 11.7 | 36.03 |
| Sugar | 8.1 | 23.70 | 7.8 | 23.84 | 7.5 | 23.09 |
| Butter-vanilla | 0.1 | 0.29 | 0.1 | 0.31 | 0.1 | 0.31 |
| flavoring | | | | | | |
| Whole egg | 0 | 0.00 | 0 | 0.00 | 0 | 0.00 |
| powder | | | | | | |
| Whole egg, | 3.8 | 11.12 | 2.74 | 8.37 | 1.8 | 5.54 |
| pasteurized | | | | | | |
| Salt | 0.18 | 0.53 | 0.18 | 0.55 | 0.175 | 0.54 |
| Wheat flour | 10 | 29.26 | 10 | 30.56 | 10 | 30.79 |
| Butter fat | 1 | 2.93 | 0.8 | 2.44 | 1.2 | 3.70 |
| Total | 34.18 | 100 | 32.72 | 100 | 32.475 | 100 |

Baking masses C:

| | Cocoa A | | Coconut A | | Coffee A | |
|---|---|---|---|---|---|---|
| Raw materials | kg | % | kg | % | kg | % |
| Water | 15.1 | 40.46 | 14.1 | 37.54 | 15 | 39.16 |
| Sugar color | 0.1 | 0.27 | 0 | 0.00 | 0 | 0.00 |
| Sugar | 9.3 | 24.92 | 9.55 | 25.43 | 9.75 | 25.46 |
| Coffee, roasted | 0 | 0.00 | 0 | 0.00 | 0.4 | 1.04 |
| ground | | | | | | |
| Coconut cream | 0 | 0.00 | 1.2 | 3.20 | 0 | 0.00 |
| Cocoa powder | 0.4 | 1.07 | 0 | 0.00 | 0 | 0.00 |
| Flavoring | 0.1 | 0.27 | 0.1 | 0.27 | 0.1 | 0.26 |
| Whole egg | 2.325 | 6.23 | 2.395 | 6.38 | 2.44 | 6.37 |
| powder | | | | | | |
| Salt | 0.2 | 0.54 | 0.21 | 0.56 | 0.21 | 0.55 |
| Wheat flour | 9.6 | 25.72 | 10 | 26.63 | 10 | 26.11 |
| Butter | 0.2 | 0.54 | 0 | 0.00 | 0.4 | 1.04 |
| Total | 37.325 | 100 | 37.555 | 100 | 38.3 | 100 |

Baking masses D:

| | Cocoa B | | Coconut B | | Coffee B | |
|---|---|---|---|---|---|---|
| Raw materials | kg | % | kg | % | kg | % |
| Water | 9 | 24.1 | 7.9 | 21.03 | 8.6 | 22.45 |
| Sugar color | 0.1 | 0.27 | 0 | 0.00 | 0 | 0.00 |
| Sugar | 9.3 | 24.95 | 9.55 | 25.43 | 9.75 | 25.45 |
| Coffee, roasted | 0 | 0.00 | 0 | 0.00 | 0.4 | 1.04 |
| ground | | | | | | |
| Coconut cream | 0 | 0.00 | 1.2 | 3.19 | 0 | 0.00 |
| Cocoa powder | 0.4 | 1.07 | 0 | 0.00 | 0 | 0.00 |
| Whole egg, | 8.37 | 22.46 | 8.6 | 22.90 | 8.8 | 22.97 |
| pasteurized | | | | | | |
| Flavoring | 0.1 | 0.27 | 0.1 | 0.27 | 0.1 | 0.26 |
| Salt | 0.2 | 0.54 | 0.21 | 0.56 | 0.21 | 0.55 |
| Wheat flour | 9.6 | 25.76 | 10 | 26.62 | 10 | 26.10 |
| Butter | 0.2 | 0.54 | 0 | 0.00 | 0.45 | 1.17 |
| Total | 37.27 | 100 | 37.56 | 100 | 38.31 | 100 |

Baking masses E1:

| | Almond A | | Peanut A | | Gingerbread A | |
|---|---|---|---|---|---|---|
| Raw materials | kg | % | kg | % | kg | % |
| Water | 15.5 | 39.09 | 15.5 | 39.09 | 14.7 | 39.68 |
| Sugar | 10.1 | 25.47 | 10.1 | 25.47 | 9.3 | 25.10 |
| Gingerbread spices, | 0 | 0.00 | 0 | 0.00 | 0.4 | 1.08 |
| ground | | | | | | |
| Flavoring | 0.1 | 0.25 | 0.1 | 0.25 | 0.1 | 0.27 |
| Whole egg powder | 2.54 | 6.41 | 2.54 | 6.41 | 2.34 | 6.32 |
| Salt | 0.21 | 0.53 | 0.21 | 0.53 | 0.21 | 0.57 |
| Peanut butter | 0 | 0.00 | 1.2 | 3.03 | 0 | 0.00 |
| Almond flour | 1.2 | 3.03 | 0 | 0.00 | 0 | 0.00 |
| Wheat flour | 10 | 25.22 | 10 | 25.22 | 10 | 26.99 |
| Butter | 0 | 0.00 | 0 | 0.00 | 0 | 0.00 |
| Total | 39.65 | 100 | 39.65 | 100 | 37.05 | 100 |

Baking masses E2:

| | | |
|---|---|---|
| Almond B | Peanut B | Gingerbread B |
| Raw materials | kg | % | kg | % | kg | % |
|---|---|---|---|---|---|---|
| Water | 8.9 | 22.45 | 8.9 | 22.45 | 8.6 | 23.24 |
| Sugar | 10.1 | 25.48 | 10.1 | 25.47 | 9.3 | 25.13 |
| Gingerbread spices, | 0 | 0.00 | 0 | 0.00 | 0.4 | 1.08 |
| ground | | | | | | |
| Whole egg, | 9.13 | 23.03 | 9.14 | 23.05 | 8.4 | 22.70 |
| pasteurized | | | | | | |
| Flavoring | 0.1 | 0.25 | 0.1 | 0.25 | 0.1 | 0.27 |
| Whole egg powder | 0 | 0.00 | 0 | 0.00 | 0 | 0.00 |
| Salt | 0.21 | 0.53 | 0.21 | 0.53 | 0.21 | 0.57 |
| Peanut butter | 0 | 0.00 | 1.2 | 3.03 | 0 | 0.00 |
| Almond flour | 1.2 | 3.03 | 0 | 0.00 | 0 | 0.00 |
| Wheat flour | 10 | 25.23 | 10 | 25.22 | 10 | 27.02 |
| Butter | 0 | 0.00 | 0 | 0.00 | 0 | 0.00 |
| Total | 39.64 | 100 | 39.65 | 100 | 37.01 | 100 |

Baking masses F:

| | Full-cream | | Skimmed | | Skimmed | |
|---|---|---|---|---|---|---|
| | milk A | | milk A | | milk C | |
| Raw materials | kg/lb | % | kg/lb | % | kg/lb | % |
| Water | 15.2 | 39.83 | 15.2 | 39.80 | 15 | 39.66 |
| Sugar color | 0 | 0.00 | 0 | 0.00 | 0 | 0.00 |
| Invert sugar | 0 | 0.00 | 0 | 0.00 | 0 | 0.00 |
| Sugar | 9.6 | 25.16 | 9.6 | 25.14 | 9.5 | 25.12 |
| Whole egg, | 0 | 0.00 | 0 | 0.00 | 0 | 0.00 |
| pasteurized | | | | | | |
| Flavoring | 0.1 | 0.26 | 0.1 | 0.26 | 0.1 | 0.26 |
| Whole egg | 1.81 | 4.74 | 1.805 | 4.73 | 1.49 | 3.94 |
| powder | | | | | | |
| Salt | 0.21 | 0.55 | 0.21 | 0.55 | 0.21 | 0.56 |
| Full-cream milk | 1.243 | 3.26 | 0 | 0.00 | 0 | 0.00 |
| powder | | | | | | |
| Skimmed milk | 0 | 0.00 | 0.926 | 2.42 | 1.02 | 2.70 |
| powder | | | | | | |
| Wheat flour | 10 | 26.20 | 10 | 26.18 | 10 | 26.44 |
| Butter | 0 | 0.00 | 0.35 | 0.92 | 0.5 | 1.32 |
| Total | 38.163 | 100 | 38.191 | 100 | 37.82 | 100 |

Baking masses G:

| | Full-cream | | Skimmed | | Skimmed | |
|---|---|---|---|---|---|---|
| | milk A | | milk A | | milk C | |
| Raw materials | kg | % | kg | % | kg | % |
| Water | 10.5 | 27.52 | 10.5 | 27.50 | 11.1 | 29.37 |
| Sugar color | 0 | 0.00 | 0 | 0.00 | 0 | 0.00 |
| Invert sugar | 0 | 0.00 | 0 | 0.00 | 0 | 0.00 |
| Sugar | 9.6 | 25.16 | 9.6 | 25.14 | 9.5 | 25.14 |
| Whole egg | 6.5 | 17.04 | 6.5 | 17.02 | 5.36 | 14.18 |
| pasteurized | | | | | | |
| Flavoring | 0.1 | 0.26 | 0.1 | 0.26 | 0.1 | 0.26 |
| Whole egg | 0 | 0.00 | 0 | 0.00 | 0 | 0.00 |
| powder | | | | | | |
| Salt | 0.21 | 0.55 | 0.21 | 0.55 | 0.21 | 0.56 |
| Full-cream milk | 1.242 | 3.26 | 0 | 0.00 | 0 | 0.00 |
| powder | | | | | | |
| Skimmed milk | 0 | 0.00 | 0.926 | 2.42 | 1.02 | 2.70 |
| powder | | | | | | |
| Wheat flour | 10 | 26.21 | 10 | 26.19 | 10 | 26.46 |
| Butter | 0 | 0.00 | 0.35 | 0.92 | 0.5 | 1.32 |
| Total | 38.152 | 100 | 38.186 | 100 | 37.79 | 100 |

Baking masses H:

| | Soya flour | | Whey protein | | Lupin flour | |
|---|---|---|---|---|---|---|
| Raw materials | kg | % | kg | % | kg | % |
| Water | 10.75 | 28.04 | 14.3 | 39.5 | 10.75 | 28.04 |
| Soya flour, toasted | 1.2 | 3.13 | 0 | 0.00 | 0 | 0.00 |
| Lupin flour, toasted | 0 | 0.00 | 0 | 0.00 | 1.2 | 3.13 |
| Sugar | 9.6 | 25.04 | 9.1 | 25.14 | 9.6 | 25.04 |
| Whole egg | 6.48 | 16.90 | 0 | 0.00 | 6.48 | 16.90 |
| pasteurized | | | | | | |
| Flavoring | 0.1 | 0.26 | 0.1 | 0.28 | 0.1 | 0.26 |
| Whole egg powder | 0 | 0.00 | 0 | 0.00 | 0 | 0.00 |
| Salt | 0.21 | 0.55 | 0.2 | 0.55 | 0.21 | 0.55 |
| Full-cream milk | 0 | 0.00 | 0 | 0.00 | 0 | 0.00 |
| powder | | | | | | |
| Whey protein | 0 | 0.00 | 1.5 | 4.14 | 0 | 0.00 |
| concentrate | | | | | | |
| Wheat flour | 10 | 26.08 | 10 | 27.63 | 10 | 26.08 |
| Butter fat | 0 | 0.00 | 1 | 2.76 | 0 | 0.00 |
| Total | 38.34 | 100 | 36.2 | 100 | 38.34 | 100 |

29. The method according to claim 21, wherein the shortening agent includes at least one of melted butter fat, butter oil, melted butter, melted margarine, lard, coconut oil, hardened coconut oil, palm olein or other vegetable oils or melted fats.

30. The method according to claim 29, wherein the shortening agent includes added flavoring.

31. The method according to claim 21, which further comprises packaging the roll wafers directly after reshaping to protect against moisture ingress, air oxygen and for hygienic reasons.

32. The method according to claim 21, wherein the baking mass is flowable.

33. The method according to claim 21, wherein the baking surface is an outer surface or an inner surface of a baking ring being rotated about its axis of rotation.

34. The method according to claim 21, which further comprises releasing the baked strip with a scraper knife.

35. The method according to claim 21, which further comprises adding the shortening agent during the winding process through a central bore in the rolling mandrel.

36. The method according to claim 21, which further comprises bringing the baked strip in contact with water before winding for improved sealing of coils of the wound baked strip.

37. The method according to claim 36, which further comprises carrying out the step of bringing the baked strip in contact with water by spraying with water or a water-based solution.

38. The method according to claim 37, wherein the water is a water-based syrup solution.

39. The method according to claim 38, wherein the water-based syrup solution includes at least one of 10 to 25% glucose syrup, 10 to 25% invert sugar syrup, 10 to 25% fructose syrup, 10 to 25% honey in water or water-based flavors for additional flavoring.

40. A method of using an annular baking machine, the method comprising the following steps:
continuously producing roll wafers having a short texture by using the annular baking machine.

41. The method of using an annular baking machine according to claim 40, wherein the roll wafers having a short texture include a shortenable baked baking mass and a shortening agent.

42. The method of using an annular baking machine according to claim 40, wherein the shortening agent is applied or can be applied to the shortenable baked baking mass.

43. The method of using an annular baking machine according to claim 40, which further comprises providing the baking mass with the following ingredients relative to 100 parts of at least one of flour or high-starch flour:
a) sugar: 65 to 105 parts or 75 to 100 parts;
b) fat: less than 14 parts, less than 8 parts or less than 6.5 parts; and
c) whole egg: 18 to 112 parts or 38 to 112 parts or equivalent quantities of animal or vegetable proteins serving as a replacement for egg protein.

44. The method of using an annular baking machine according to claim 40, which further comprises providing the baking mass with ingredients lying in a range of the ingredients of baking masses A, baking masses B, baking masses C, baking masses D, baking masses E1, baking masses E2, baking masses F, baking masses G or baking masses H:
Baking masses A

| | 50% | | 45% | | 40% | |
|---|---|---|---|---|---|---|
| | egg | | egg | | egg | |
| | fraction | | fraction | | fraction | |
| Raw materials | kg | % | kg | % | kg | % |
| Water | 15.4 | 39.47 | 15.1 | 39.61 | 14.75 | 39.61 |
| Sugar | 10 | 25.63 | 9.7 | 25.45 | 9.375 | 25.18 |
| Butter-vanilla | 0.1 | 0.26 | 0.1 | 0.26 | 0.1 | 0.27 |
| flavoring | | | | | | |
| Whole egg | 3.095 | 7.93 | 2.71 | 7.11 | 2.35 | 6.31 |
| powder | | | | | | |
| Whole egg, | 0 | 0.00 | 0 | 0.00 | 0 | 0.00 |
| pasteurized | | | | | | |
| Salt | 0.22 | 0.56 | 0.21 | 0.55 | 0.21 | 0.56 |
| Wheat flour | 10 | 25.63 | 10 | 26.23 | 10 | 26.86 |
| Butter fat | 0.2 | 0.51 | 0.3 | 0.79 | 0.45 | 1.21 |
| Total | 39.015 | 100 | 38.12 | 100 | 37.235 | 100 |
| | 35% | | 30% | | 25% | |
| | egg | | egg | | egg | |
| | fraction | | fraction | | fraction | |
| Raw materials | kg | % | kg | % | kg | % |
| Water | 14.45 | 39.69 | 14.1 | 39.70 | 14.5 | 40.97 |
| Sugar | 9.06 | 24.88 | 8.7 | 24.50 | 8.45 | 23.87 |
| Butter-vanilla | 0.1 | 0.27 | 0.1 | 0.28 | 0.1 | 0.28 |
| flavoring | | | | | | |
| Whole egg | 2 | 5.49 | 1.67 | 4.70 | 1.356 | 3.83 |
| powder | | | | | | |
| Whole egg, | 0 | 0.00 | 0 | 0.00 | 0 | 0.00 |
| pasteurized | | | | | | |
| Salt | 0.2 | 0.55 | 0.195 | 0.55 | 0.19 | 0.54 |
| Wheat flour | 10 | 27.46 | 10 | 28.16 | 10 | 28.25 |
| Butter fat | 0.6 | 1.65 | 0.75 | 2.11 | 0.8 | 2.26 |
| Total | 36.41 | 100 | 35.515 | 100 | 35.396 | 100 |
| | 20% | | 15% | | 10% | |
| | egg | | egg | | egg | |
| | fraction | | fraction | | fraction | |
| Raw materials | kg | % | kg | % | kg | % |
| Water | 13.55 | 39.87 | 13.1 | 40.01 | 13 | 40.03 |
| Sugar | 8.1 | 23.83 | 7.8 | 23.82 | 7.5 | 23.09 |
| Butter-vanilla | 0.1 | 0.29 | 0.1 | 0.31 | 0.1 | 0.31 |
| flavoring | | | | | | |
| Whole egg | 1.055 | 3.10 | 0.76 | 2.32 | 0.5 | 1.54 |
| powder | | | | | | |
| Whole egg, | 0 | 0.00 | 0 | 0.00 | 0 | 0.00 |
| pasteurized | | | | | | |
| Salt | 0.18 | 0.53 | 0.18 | 0.55 | 0.175 | 0.54 |
| Wheat flour | 10 | 29.42 | 10 | 30.54 | 10 | 30.79 |
| Butter fat | 1 | 2.94 | 0.8 | 2.44 | 1.2 | 3.70 |
| Total | 33.985 | 100 | 32.74 | 100 | 32.475 | 100 |

Baking masses B:

| | 50% | | 45% | | 40% | |
|---|---|---|---|---|---|---|
| | egg | | egg | | egg | |
| | fraction | | fraction | | fraction | |
| Raw materials | kg | % | kg | % | kg | % |
| Water | 7.3 | 18.74 | 8 | 21.01 | 8.6 | 23.13 |
| Sugar | 10 | 25.67 | 9.7 | 25.48 | 9.375 | 25.21 |
| Butter-vanilla | 0.1 | 0.26 | 0.1 | 0.26 | 0.1 | 0.27 |
| flavoring | | | | | | |
| Whole egg | 0 | 0.00 | 0 | 0.00 | 0 | 0.00 |
| powder | | | | | | |
| Whole egg, | 11.14 | 28.59 | 9.76 | 25.64 | 8.45 | 22.72 |
| pasteurized | | | | | | |
| Salt | 0.22 | 0.56 | 0.21 | 0.55 | 0.21 | 0.56 |
| Wheat flour | 10 | 25.67 | 10 | 26.27 | 10 | 26.89 |
| Butter fat | 0.2 | 0.51 | 0.3 | 0.79 | 0.45 | 1.21 |
| Total | 38.96 | 100 | 38.07 | 100 | 37.185 | 100 |
| | 35% | | 30% | | 25% | |
| | egg | | egg | | egg | |
| | fraction | | fraction | | fraction | |
| Raw materials | kg | % | kg | % | kg | % |
| Water | 9.2 | 25.20 | 9.75 | 27.47 | 10.95 | 30.96 |
| Sugar | 9.06 | 24.92 | 8.7 | 24.51 | 8.45 | 23.89 |
| Butter-vanilla | 0.1 | 0.28 | 0.1 | 0.28 | 0.1 | 0.28 |
| flavoring | | | | | | |
| Whole egg | 0 | 0.00 | 0 | 0.00 | 0 | 0.00 |
| powder | | | | | | |
| Whole egg, | 7.2 | 19.80 | 6 | 16.90 | 4.88 | 13.80 |
| pasteurized | | | | | | |
| Salt | 0.2 | 0.55 | 0.195 | 0.55 | 0.19 | 0.54 |
| Wheat flour | 10 | 27.50 | 10 | 28.17 | 10 | 28.27 |
| Butter fat | 0.6 | 1.65 | 0.75 | 2.11 | 0.8 | 2.26 |
| Total | 36.36 | 100 | 35.495 | 100 | 35.37 | 100 |
| | 20% | | 15% | | 10% | |
| | egg | | egg | | egg | |
| | fraction | | fraction | | fraction | |
| Raw materials | kg | % | kg | % | kg | % |
| Water | 11 | 32.18 | 11.1 | 33.92 | 11.7 | 36.03 |
| Sugar | 8.1 | 23.70 | 7.8 | 23.84 | 7.5 | 23.09 |
| Butter-vanilla | 0.1 | 0.29 | 0.1 | 0.31 | 0.1 | 0.31 |
| flavoring | | | | | | |
| Whole egg | 0 | 0.00 | 0 | 0.00 | 0 | 0.00 |
| powder | | | | | | |
| Whole egg, | 3.8 | 11.12 | 2.74 | 8.37 | 1.8 | 5.54 |
| pasteurized | | | | | | |
| Salt | 0.18 | 0.53 | 0.18 | 0.55 | 0.175 | 0.54 |
| Wheat flour | 10 | 29.26 | 10 | 30.56 | 10 | 30.79 |
| Butter fat | 1 | 2.93 | 0.8 | 2.44 | 1.2 | 3.70 |
| Total | 34.18 | 100 | 32.72 | 100 | 32.475 | 100 |

Baking masses C:

| | Cocoa A | | Coconut A | | Coffee A | |
|---|---|---|---|---|---|---|
| Raw materials | kg | % | kg | % | kg | % |
| Water | 15.1 | 40.46 | 14.1 | 37.54 | 15 | 39.16 |
| Sugar color | 0.1 | 0.27 | 0 | 0.00 | 0 | 0.00 |
| Sugar | 9.3 | 24.92 | 9.55 | 25.43 | 9.75 | 25.46 |
| Coffee, roasted | 0 | 0.00 | 0 | 0.00 | 0.4 | 1.04 |
| ground | | | | | | |
| Coconut cream | 0 | 0.00 | 1.2 | 3.20 | 0 | 0.00 |
| Cocoa powder | 0.4 | 1.07 | 0 | 0.00 | 0 | 0.00 |
| Flavoring | 0.1 | 0.27 | 0.1 | 0.27 | 0.1 | 0.26 |
| Whole egg | 2.325 | 6.23 | 2.395 | 6.38 | 2.44 | 6.37 |
| powder | | | | | | |
| Salt | 0.2 | 0.54 | 0.21 | 0.56 | 0.21 | 0.55 |
| Wheat flour | 9.6 | 25.72 | 10 | 26.63 | 10 | 26.11 |
| Butter | 0.2 | 0.54 | 0 | 0.00 | 0.4 | 1.04 |
| Total | 37.325 | 100 | 37.555 | 100 | 38.3 | 100 |

Baking masses D:

| | Cocoa B | | Coconut B | | Coffee B | |
|---|---|---|---|---|---|---|
| Raw materials | kg | % | kg | % | kg | % |
| Water | 9 | 24.1 | 7.9 | 21.03 | 8.6 | 22.45 |
| Sugar color | 0.1 | 0.27 | 0 | 0.00 | 0 | 0.00 |
| Sugar | 9.3 | 24.95 | 9.55 | 25.43 | 9.75 | 25.45 |
| Coffee, roasted | 0 | 0.00 | 0 | 0.00 | 0.4 | 1.04 |
| ground | | | | | | |
| Coconut cream | 0 | 0.00 | 1.2 | 3.19 | 0 | 0.00 |
| Cocoa powder | 0.4 | 1.07 | 0 | 0.00 | 0 | 0.00 |
| Whole egg, | 8.37 | 22.46 | 8.6 | 22.90 | 8.8 | 22.97 |
| pasteurized | | | | | | |
| Flavoring | 0.1 | 0.27 | 0.1 | 0.27 | 0.1 | 0.26 |
| Salt | 0.2 | 0.54 | 0.21 | 0.56 | 0.21 | 0.55 |
| Wheat flour | 9.6 | 25.76 | 10 | 26.62 | 10 | 26.10 |
| Butter | 0.2 | 0.54 | 0 | 0.00 | 0.45 | 1.17 |
| Total | 37.27 | 100 | 37.56 | 100 | 38.31 | 100 |

Baking masses E1:

| | Almond A | | Peanut A | | Gingerbread A | |
|---|---|---|---|---|---|---|
| Raw materials | kg | % | kg | % | kg | % |
| Water | 15.5 | 39.09 | 15.5 | 39.09 | 14.7 | 39.68 |
| Sugar | 10.1 | 25.47 | 10.1 | 25.47 | 9.3 | 25.10 |
| Gingerbread spices, | 0 | 0.00 | 0 | 0.00 | 0.4 | 1.08 |
| ground | | | | | | |
| Flavoring | 0.1 | 0.25 | 0.1 | 0.25 | 0.1 | 0.27 |
| Whole egg powder | 2.54 | 6.41 | 2.54 | 6.41 | 2.34 | 6.32 |
| Salt | 0.21 | 0.53 | 0.21 | 0.53 | 0.21 | 0.57 |
| Peanut butter | 0 | 0.00 | 1.2 | 3.03 | 0 | 0.00 |
| Almond flour | 1.2 | 3.03 | 0 | 0.00 | 0 | 0.00 |
| Wheat flour | 10 | 25.22 | 10 | 25.22 | 10 | 26.99 |
| Butter | 0 | 0.00 | 0 | 0.00 | 0 | 0.00 |
| Total | 39.65 | 100 | 39.65 | 100 | 37.05 | 100 |

Baking masses E2:

| | Almond B | | Peanut B | | Gingerbread B | |
|---|---|---|---|---|---|---|
| Raw materials | kg | % | kg | % | kg | % |
| Water | 8.9 | 22.45 | 8.9 | 22.45 | 8.6 | 23.24 |
| Sugar | 10.1 | 25.48 | 10.1 | 25.47 | 9.3 | 25.13 |
| Gingerbread spices, | 0 | 0.00 | 0 | 0.00 | 0.4 | 1.08 |
| ground | | | | | | |
| Whole egg, | 9.13 | 23.03 | 9.14 | 23.05 | 8.4 | 22.70 |
| pasteurized | | | | | | |
| Flavoring | 0.1 | 0.25 | 0.1 | 0.25 | 0.1 | 0.27 |
| Whole egg powder | 0 | 0.00 | 0 | 0.00 | 0 | 0.00 |
| Salt | 0.21 | 0.53 | 0.21 | 0.53 | 0.21 | 0.57 |
| Peanut butter | 0 | 0.00 | 1.2 | 3.03 | 0 | 0.00 |
| Almond flour | 1.2 | 3.03 | 0 | 0.00 | 0 | 0.00 |
| Wheat flour | 10 | 25.23 | 10 | 25.22 | 10 | 27.02 |
| Butter | 0 | 0.00 | 0 | 0.00 | 0 | 0.00 |
| Total | 39.64 | 100 | 39.65 | 100 | 37.01 | 100 |

Baking masses F:

| | Full-cream milk | | Skimmed milk | | Skimmed milk | |
|---|---|---|---|---|---|---|
| | A | | A | | C | |
| Raw materials | kg/lb | % | kg/lb | % | kg/lb | % |
| Water | 15.2 | 39.83 | 15.2 | 39.80 | 15 | 39.66 |
| Sugar color | 0 | 0.00 | 0 | 0.00 | 0 | 0.00 |
| Invert sugar | 0 | 0.00 | 0 | 0.00 | 0 | 0.00 |
| Sugar | 9.6 | 25.16 | 9.6 | 25.14 | 9.5 | 25.12 |
| Whole egg, | 0 | 0.00 | 0 | 0.00 | 0 | 0.00 |
| pasteurized | | | | | | |
| Flavoring | 0.1 | 0.26 | 0.1 | 0.26 | 0.1 | 0.26 |
| Whole egg | 1.81 | 4.74 | 1.805 | 4.73 | 1.49 | 3.94 |
| powder | | | | | | |
| Salt | 0.21 | 0.55 | 0.21 | 0.55 | 0.21 | 0.56 |
| Full-cream | 1.243 | 3.26 | 0 | 0.00 | 0 | 0.00 |
| milk powder | | | | | | |
| Skimmed | 0 | 0.00 | 0.926 | 2.42 | 1.02 | 2.70 |
| milk powder | | | | | | |
| Wheat flour | 10 | 26.20 | 10 | 26.18 | 10 | 26.44 |
| Butter | 0 | 0.00 | 0.35 | 0.92 | 0.5 | 1.32 |
| Total | 38.163 | 100 | 38.191 | 100 | 37.82 | 100 |

Baking masses G:

| | Full-cream milk | | Skimmed milk | | Skimmed milk | |
|---|---|---|---|---|---|---|
| | A | | A | | C | |
| Raw materials | kg | % | kg | % | kg | % |
| Water | 10.5 | 27.52 | 10.5 | 27.50 | 11.1 | 29.37 |
| Sugar color | 0 | 0.00 | 0 | 0.00 | 0 | 0.00 |
| Invert sugar | 0 | 0.00 | 0 | 0.00 | 0 | 0.00 |
| Sugar | 9.6 | 25.16 | 9.6 | 25.14 | 9.5 | 25.14 |
| Whole egg | 6.5 | 17.04 | 6.5 | 17.02 | 5.36 | 14.18 |
| pasteurized | | | | | | |
| Flavoring | 0.1 | 0.26 | 0.1 | 0.26 | 0.1 | 0.26 |
| Whole egg | 0 | 0.00 | 0 | 0.00 | 0 | 0.00 |
| powder | | | | | | |
| Salt | 0.21 | 0.55 | 0.21 | 0.55 | 0.21 | 0.56 |
| Full-cream | 1.242 | 3.26 | 0 | 0.00 | 0 | 0.00 |
| milk powder | | | | | | |
| Skimmed | 0 | 0.00 | 0.926 | 2.42 | 1.02 | 2.70 |
| milk powder | | | | | | |
| Wheat flour | 10 | 26.21 | 10 | 26.19 | 10 | 26.46 |
| Butter | 0 | 0.00 | 0.35 | 0.92 | 0.5 | 1.32 |
| Total | 38.152 | 100 | 38.186 | 100 | 37.79 | 100 |

Baking masses H:

| | Soya flour | | Whey protein | | Lupin flour | |
|---|---|---|---|---|---|---|
| Raw materials | kg | % | kg | % | kg | % |
| Water | 10.75 | 28.04 | 14.3 | 39.5 | 10.75 | 28.04 |
| Soya flour, toasted | 1.2 | 3.13 | 0 | 0.00 | 0 | 0.00 |
| Lupin flour, toasted | 0 | 0.00 | 0 | 0.00 | 1.2 | 3.13 |
| Sugar | 9.6 | 25.04 | 9.1 | 25.14 | 9.6 | 25.04 |
| Whole egg | 6.48 | 16.90 | 0 | 0.00 | 6.48 | 16.90 |
| pasteurized | | | | | | |
| Flavoring | 0.1 | 0.26 | 0.1 | 0.28 | 0.1 | 0.26 |
| Whole egg powder | 0 | 0.00 | 0 | 0.00 | 0 | 0.00 |
| Salt | 0.21 | 0.55 | 0.2 | 0.55 | 0.21 | 0.55 |
| Full-cream milk | 0 | 0.00 | 0 | 0.00 | 0 | 0.00 |
| powder | | | | | | |
| Whey protein | 0 | 0.00 | 1.5 | 4.14 | 0 | 0.00 |
| concentrate | | | | | | |
| Wheat flour | 10 | 26.08 | 10 | 27.63 | 10 | 26.08 |
| Butter fat | 0 | 0.00 | 1 | 2.76 | 0 | 0.00 |
| Total | 38.34 | 100 | 36.2 | 100 | 38.34 | 100 |

45. The method of using an annular baking machine according to claim 40, which further comprises providing the baking mass with substantially one of baking masses A, baking masses B, baking masses C, baking masses D, baking masses E1, baking masses E2, baking masses F, baking masses G or baking masses H:
Baking masses A

| | 50% egg | | 45% egg | | 40% egg | |
|---|---|---|---|---|---|---|
| | fraction | | fraction | | fraction | |
| Raw materials | kg | % | kg | % | kg | % |
| Water | 15.4 | 39.47 | 15.1 | 39.61 | 14.75 | 39.61 |
| Sugar | 10 | 25.63 | 9.7 | 25.45 | 9.375 | 25.18 |
| Butter-vanilla | 0.1 | 0.26 | 0.1 | 0.26 | 0.1 | 0.27 |
| flavoring | | | | | | |
| Whole egg powder | 3.095 | 7.93 | 2.71 | 7.11 | 2.35 | 6.31 |
| Whole egg, | 0 | 0.00 | 0 | 0.00 | 0 | 0.00 |
| pasteurized | | | | | | |
| Salt | 0.22 | 0.56 | 0.21 | 0.55 | 0.21 | 0.56 |
| Wheat flour | 10 | 25.63 | 10 | 26.23 | 10 | 26.86 |
| Butter fat | 0.2 | 0.51 | 0.3 | 0.79 | 0.45 | 1.21 |
| Total | 39.015 | 100 | 38.12 | 100 | 37.235 | 100 |
| | 35% egg | | 30% egg | | 25% egg | |
|---|---|---|---|---|---|---|
| | fraction | | fraction | | fraction | |
| Raw materials | kg | % | kg | % | kg | % |
| Water | 14.45 | 39.69 | 14.1 | 39.70 | 14.5 | 40.97 |
| Sugar | 9.06 | 24.88 | 8.7 | 24.50 | 8.45 | 23.87 |
| Butter-vanilla | 0.1 | 0.27 | 0.1 | 0.28 | 0.1 | 0.28 |
| flavoring | | | | | | |
| Whole egg powder | 2 | 5.49 | 1.67 | 4.70 | 1.356 | 3.83 |
| Whole egg, | 0 | 0.00 | 0 | 0.00 | 0 | 0.00 |
| pasteurized | | | | | | |
| Salt | 0.2 | 0.55 | 0.195 | 0.55 | 0.19 | 0.54 |
| Wheat flour | 10 | 27.46 | 10 | 28.16 | 10 | 28.25 |
| Butter fat | 0.6 | 1.65 | 0.75 | 2.11 | 0.8 | 2.26 |
| Total | 36.41 | 100 | 35.515 | 100 | 35.396 | 100 |
| | 20% egg | | 15% egg | | 10% egg | |
| | fraction | | fraction | | fraction | |
| Raw materials | kg | % | kg | % | kg | % |
| Water | 13.55 | 39.87 | 13.1 | 40.01 | 13 | 40.03 |
| Sugar | 8.1 | 23.83 | 7.8 | 23.82 | 7.5 | 23.09 |
| Butter-vanilla | 0.1 | 0.29 | 0.1 | 0.31 | 0.1 | 0.31 |
| flavoring | | | | | | |
| Whole egg powder | 1.055 | 3.10 | 0.76 | 2.32 | 0.5 | 1.54 |
| Whole egg, | 0 | 0.00 | 0 | 0.00 | 0 | 0.00 |
| pasteurized | | | | | | |
| Salt | 0.18 | 0.53 | 0.18 | 0.55 | 0.175 | 0.54 |
| Wheat flour | 10 | 29.42 | 10 | 30.54 | 10 | 30.79 |
| Butter fat | 1 | 2.94 | 0.8 | 2.44 | 1.2 | 3.70 |
| Total | 33.985 | 100 | 32.74 | 100 | 32.475 | 100 |

Baking masses B:

| | 50% egg | | 45% egg | | 40% egg | |
|---|---|---|---|---|---|---|
| | fraction | | fraction | | fraction | |
| Raw materials | kg | % | kg | % | kg | % |
| Water | 7.3 | 18.74 | 8 | 21.01 | 8.6 | 23.13 |
| Sugar | 10 | 25.67 | 9.7 | 25.48 | 9.375 | 25.21 |
| Butter-vanilla | 0.1 | 0.26 | 0.1 | 0.26 | 0.1 | 0.27 |
| flavoring | | | | | | |
| Whole egg powder | 0 | 0.00 | 0 | 0.00 | 0 | 0.00 |
| Whole egg, | 11.14 | 28.59 | 9.76 | 25.64 | 8.45 | 22.72 |
| pasteurized | | | | | | |
| Salt | 0.22 | 0.56 | 0.21 | 0.55 | 0.21 | 0.56 |
| Wheat flour | 10 | 25.67 | 10 | 26.27 | 10 | 26.89 |
| Butter fat | 0.2 | 0.51 | 0.3 | 0.79 | 0.45 | 1.21 |
| Total | 38.96 | 100 | 38.07 | 100 | 37.185 | 100 |
| | 35% egg | | 30% egg | | 25% egg | |
| | fraction | | fraction | | fraction | |
| Raw materials | kg | % | kg | % | kg | % |
| Water | 9.2 | 25.20 | 9.75 | 27.47 | 10.95 | 30.96 |
| Sugar | 9.06 | 24.92 | 8.7 | 24.51 | 8.45 | 23.89 |
| Butter-vanilla | 0.1 | 0.28 | 0.1 | 0.28 | 0.1 | 0.28 |
| flavoring | | | | | | |
| Whole egg powder | 0 | 0.00 | 0 | 0.00 | 0 | 0.00 |
| Whole egg, | 7.2 | 19.80 | 6 | 16.90 | 4.88 | 13.80 |
| pasteurized | | | | | | |
| Salt | 0.2 | 0.55 | 0.195 | 0.55 | 0.19 | 0.54 |
| Wheat flour | 10 | 27.50 | 10 | 28.17 | 10 | 28.27 |
| Butter fat | 0.6 | 1.65 | 0.75 | 2.11 | 0.8 | 2.26 |
| Total | 36.36 | 100 | 35.495 | 100 | 35.37 | 100 |
| | 20% egg | | 15% egg | | 10% egg | |
| | fraction | | fraction | | fraction | |
| Raw materials | kg | % | kg | % | kg | % |
| Water | 11 | 32.18 | 11.1 | 33.92 | 11.7 | 36.03 |
| Sugar | 8.1 | 23.70 | 7.8 | 23.84 | 7.5 | 23.09 |
| Butter-vanilla | 0.1 | 0.29 | 0.1 | 0.31 | 0.1 | 0.31 |
| flavoring | | | | | | |
| Whole egg powder | 0 | 0.00 | 0 | 0.00 | 0 | 0.00 |
| Whole egg, | 3.8 | 11.12 | 2.74 | 8.37 | 1.8 | 5.54 |
| pasteurized | | | | | | |
| Salt | 0.18 | 0.53 | 0.18 | 0.55 | 0.175 | 0.54 |
| Wheat flour | 10 | 29.26 | 10 | 30.56 | 10 | 30.79 |
| Butter fat | 1 | 2.93 | 0.8 | 2.44 | 1.2 | 3.70 |
| Total | 34.18 | 100 | 32.72 | 100 | 32.475 | 100 |

Baking masses C:

| | Cocoa A | | Coconut A | | Coffee A | |
|---|---|---|---|---|---|---|
| Raw materials | kg | % | kg | % | kg | % |
| Water | 15.1 | 40.46 | 14.1 | 37.54 | 15 | 39.16 |
| Sugar color | 0.1 | 0.27 | 0 | 0.00 | 0 | 0.00 |
| Sugar | 9.3 | 24.92 | 9.55 | 25.43 | 9.75 | 25.46 |
| Coffee, roasted | 0 | 0.00 | 0 | 0.00 | 0.4 | 1.04 |
| ground | | | | | | |
| Coconut cream | 0 | 0.00 | 1.2 | 3.20 | 0 | 0.00 |
| Cocoa powder | 0.4 | 1.07 | 0 | 0.00 | 0 | 0.00 |
| Flavoring | 0.1 | 0.27 | 0.1 | 0.27 | 0.1 | 0.26 |
| Whole | 2.325 | 6.23 | 2.395 | 6.38 | 2.44 | 6.37 |
| egg powder | | | | | | |
| Salt | 0.2 | 0.54 | 0.21 | 0.56 | 0.21 | 0.55 |
| Wheat flour | 9.6 | 25.72 | 10 | 26.63 | 10 | 26.11 |
| Butter | 0.2 | 0.54 | 0 | 0.00 | 0.4 | 1.04 |
| Total | 37.325 | 100 | 37.555 | 100 | 38.3 | 100 |

Baking masses D:

| | Cocoa B | | Coconut B | | Coffee B | |
|---|---|---|---|---|---|---|
| Raw materials | kg | % | kg | % | kg | % |
| Water | 9 | 24.1 | 7.9 | 21.03 | 8.6 | 22.45 |
| Sugar color | 0.1 | 0.27 | 0 | 0.00 | 0 | 0.00 |
| Sugar | 9.3 | 24.95 | 9.55 | 25.43 | 9.75 | 25.45 |
| Coffee, roasted | 0 | 0.00 | 0 | 0.00 | 0.4 | 1.04 |
| ground | | | | | | |
| Coconut cream | 0 | 0.00 | 1.2 | 3.19 | 0 | 0.00 |
| Cocoa powder | 0.4 | 1.07 | 0 | 0.00 | 0 | 0.00 |
| Whole egg, | 8.37 | 22.46 | 8.6 | 22.90 | 8.8 | 22.97 |
| pasteurized | | | | | | |
| Flavoring | 0.1 | 0.27 | 0.1 | 0.27 | 0.1 | 0.26 |
| Salt | 0.2 | 0.54 | 0.21 | 0.56 | 0.21 | 0.55 |
| Wheat flour | 9.6 | 25.76 | 10 | 26.62 | 10 | 26.10 |
| Butter | 0.2 | 0.54 | 0 | 0.00 | 0.45 | 1.17 |
| Total | 37.27 | 100 | 37.56 | 100 | 38.31 | 100 |

Baking masses E1:

| | Almond A | | Peanut A | | Gingerbread A | |
|---|---|---|---|---|---|---|
| Raw materials | kg | % | kg | % | kg | % |
| Water | 15.5 | 39.09 | 15.5 | 39.09 | 14.7 | 39.68 |
| Sugar | 10.1 | 25.47 | 10.1 | 25.47 | 9.3 | 25.10 |
| Gingerbread spices, | 0 | 0.00 | 0 | 0.00 | 0.4 | 1.08 |
| ground | | | | | | |
| Flavoring | 0.1 | 0.25 | 0.1 | 0.25 | 0.1 | 0.27 |
| Whole egg powder | 2.54 | 6.41 | 2.54 | 6.41 | 2.34 | 6.32 |
| Salt | 0.21 | 0.53 | 0.21 | 0.53 | 0.21 | 0.57 |
| Peanut butter | 0 | 0.00 | 1.2 | 3.03 | 0 | 0.00 |
| Almond flour | 1.2 | 3.03 | 0 | 0.00 | 0 | 0.00 |
| Wheat flour | 10 | 25.22 | 10 | 25.22 | 10 | 26.99 |
| Butter | 0 | 0.00 | 0 | 0.00 | 0 | 0.00 |
| Total | 39.65 | 100 | 39.65 | 100 | 37.05 | 100 |

Baking masses E2:

| | Almond B | | Peanut B | | Gingerbread B | |
|---|---|---|---|---|---|---|
| Raw materials | kg | % | kg | % | kg | % |
| Water | 8.9 | 22.45 | 8.9 | 22.45 | 8.6 | 23.24 |
| Sugar | 10.1 | 25.48 | 10.1 | 25.47 | 9.3 | 25.13 |
| Gingerbread spices, | 0 | 0.00 | 0 | 0.00 | 0.4 | 1.08 |
| ground | | | | | | |
| Whole egg, | 9.13 | 23.03 | 9.14 | 23.05 | 8.4 | 22.70 |
| pasteurized | | | | | | |
| Flavoring | 0.1 | 0.25 | 0.1 | 0.25 | 0.1 | 0.27 |
| Whole egg powder | 0 | 0.00 | 0 | 0.00 | 0 | 0.00 |
| Salt | 0.21 | 0.53 | 0.21 | 0.53 | 0.21 | 0.57 |
| Peanut butter | 0 | 0.00 | 1.2 | 3.03 | 0 | 0.00 |
| Almond flour | 1.2 | 3.03 | 0 | 0.00 | 0 | 0.00 |
| Wheat flour | 10 | 25.23 | 10 | 25.22 | 10 | 27.02 |
| Butter | 0 | 0.00 | 0 | 0.00 | 0 | 0.00 |
| Total | 39.64 | 100 | 39.65 | 100 | 37.01 | 100 |

Baking masses F:

| | Full-cream milk | | Skimmed milk | | Skimmed milk | |
|---|---|---|---|---|---|---|
| | A | | A | | C | |
| Raw materials | kg/lb | % | kg/lb | % | kg/lb | % |
| Water | 15.2 | 39.83 | 15.2 | 39.80 | 15 | 39.66 |
| Sugar color | 0 | 0.00 | 0 | 0.00 | 0 | 0.00 |
| Invert sugar | 0 | 0.00 | 0 | 0.00 | 0 | 0.00 |
| Sugar | 9.6 | 25.16 | 9.6 | 25.14 | 9.5 | 25.12 |
| Whole egg, | 0 | 0.00 | 0 | 0.00 | 0 | 0.00 |
| pasteurized | | | | | | |
| Flavoring | 0.1 | 0.26 | 0.1 | 0.26 | 0.1 | 0.26 |
| Whole | 1.81 | 4.74 | 1.805 | 4.73 | 1.49 | 3.94 |
| egg powder | | | | | | |
| Salt | 0.21 | 0.55 | 0.21 | 0.55 | 0.21 | 0.56 |
| Full-cream | 1.243 | 3.26 | 0 | 0.00 | 0 | 0.00 |
| milk powder | | | | | | |
| Skimmed | 0 | 0.00 | 0.926 | 2.42 | 1.02 | 2.70 |
| milk powder | | | | | | |
| Wheat flour | 10 | 26.20 | 10 | 26.18 | 10 | 26.44 |
| Butter | 0 | 0.00 | 0.35 | 0.92 | 0.5 | 1.32 |
| Total | 38.163 | 100 | 38.191 | 100 | 37.82 | 100 |

Baking masses G:

| | Full-cream milk | | Skimmed milk | | Skimmed milk | |
|---|---|---|---|---|---|---|
| | A | | A | | C | |
| Raw materials | kg | % | kg | % | kg | % |
| Water | 10.5 | 27.52 | 10.5 | 27.50 | 11.1 | 29.37 |
| Sugar color | 0 | 0.00 | 0 | 0.00 | 0 | 0.00 |
| Invert sugar | 0 | 0.00 | 0 | 0.00 | 0 | 0.00 |
| Sugar | 9.6 | 25.16 | 9.6 | 25.14 | 9.5 | 25.14 |
| Whole egg | 6.5 | 17.04 | 6.5 | 17.02 | 5.36 | 14.18 |
| pasteurized | | | | | | |
| Flavoring | 0.1 | 0.26 | 0.1 | 0.26 | 0.1 | 0.26 |
| Whole | 0 | 0.00 | 0 | 0.00 | 0 | 0.00 |
| egg powder | | | | | | |
| Salt | 0.21 | 0.55 | 0.21 | 0.55 | 0.21 | 0.56 |
| Full-cream | 1.242 | 3.26 | 0 | 0.00 | 0 | 0.00 |
| milk powder | | | | | | |
| Skimmed | 0 | 0.00 | 0.926 | 2.42 | 1.02 | 2.70 |
| milk powder | | | | | | |
| Wheat flour | 10 | 26.21 | 10 | 26.19 | 10 | 26.46 |
| Butter | 0 | 0.00 | 0.35 | 0.92 | 0.5 | 1.32 |
| Total | 38.152 | 100 | 38.186 | 100 | 37.79 | 100 |

Baking masses H:

| | Soya flour | | Whey protein | | Lupin flour | |
|---|---|---|---|---|---|---|
| Raw materials | kg | % | kg | % | kg | % |
| Water | 10.75 | 28.04 | 14.3 | 39.5 | 10.75 | 28.04 |
| Soya flour, toasted | 1.2 | 3.13 | 0 | 0.00 | 0 | 0.00 |
| Lupin flour, toasted | 0 | 0.00 | 0 | 0.00 | 1.2 | 3.13 |
| Sugar | 9.6 | 25.04 | 9.1 | 25.14 | 9.6 | 25.04 |
| Whole egg | 6.48 | 16.90 | 0 | 0.00 | 6.48 | 16.90 |
| pasteurized | | | | | | |
| Flavoring | 0.1 | 0.26 | 0.1 | 0.28 | 0.1 | 0.26 |
| Whole egg powder | 0 | 0.00 | 0 | 0.00 | 0 | 0.00 |
| Salt | 0.21 | 0.55 | 0.2 | 0.55 | 0.21 | 0.55 |
| Full-cream milk | 0 | 0.00 | 0 | 0.00 | 0 | 0.00 |
| powder | | | | | | |
| Whey protein | 0 | 0.00 | 1.5 | 4.14 | 0 | 0.00 |
| concentrate | | | | | | |
| Wheat flour | 10 | 26.08 | 10 | 27.63 | 10 | 26.08 |
| Butter fat | 0 | 0.00 | 1 | 2.76 | 0 | 0.00 |
| Total | 38.34 | 100 | 36.2 | 100 | 38.34 | 100 |
